(19) United States
(12) Patent Application Publication
(10) Pub. No.: US 2019/0236728 A1
(43) Pub. Date: Aug. 1, 2019

(54) METHOD AND APPARATUS FOR PROVIDING INFORMATION

(71) Applicant: Alibaba Group Holding Limited, Grand Cayman (KY)

(72) Inventor: Yan Zhang, Zhejiang (CN)

(21) Appl. No.: 16/380,457

(22) Filed: Apr. 10, 2019

Related U.S. Application Data
(63) Continuation of application No. PCT/CN2017/106074, filed on Oct. 13, 2017.

(30) Foreign Application Priority Data
Oct. 26, 2016 (CN) 201610951095.4

(51) Int. Cl. G06Q 50/14; G06Q 30/06; G06F 16/9537; G06F 3/0482

(52) U.S. Cl. CPC G06Q 50/14; G06F 3/0482; G06F 16/9537; G06Q 30/0627

(57) ABSTRACT

A client terminal device provides a first user interface, wherein the first user interface comprises an event display region and a calendar display region. The client terminal device obtains a travel destination and determines a search time period; acquires, according to the travel destination and the search time period, an event occurring at the travel destination in the search time period; and displays the first user interface, wherein information about the acquired event is displayed in the event display region of the first user interface, and a calendar related to the search time period is displayed in the calendar display region. In the present disclosure, dimensions for determining a travel plan based on events are added, so that a user may conveniently determine a suitable travel plan and may save network traffic, thus reducing power consumption of a terminal and resource overhead of a server.

### CROSS REFERENCE TO RELATED PATENT APPLICATIONS

This application claims priority to and is a continuation of PCT Patent Application No. PCT/CN2017/106074, filed on 13 Oct. 2017 and entitled “METHOD AND APPARATUS FOR PROVIDING INFORMATION,” which claims priority to Chinese Patent Application No. 201610951095.4 filed on 26 Oct. 2016 and entitled “METHOD AND APPARATUS FOR PROVIDING INFORMATION,” which are incorporated herein by reference in their entirety.

### TECHNICAL FIELD

The present disclosure relates to the field of Internet data processing technologies, and, more particularly, to methods and apparatuses for providing information.

### BACKGROUND

With the continuous development of Internet technologies, various applications based on the Internet technologies have emerged to meet the requirements in people's daily life. For example, some websites may provide price information for air tickets and train or bus tickets; some websites may provide information for special festivals in tourist attractions; and some websites may provide information of social hot spots at present and in the future time, and so on. Users make travel plans by querying information provided by these websites.

The foregoing websites each provide a single type of information. Therefore, when planning a trip to a destination, a user usually needs to visit multiple websites to determine an appropriate travel time. As shown, the foregoing process has poor user experience and low efficiency. Moreover, excessive network traffic also increases power consumption of a terminal and occupied resources of a server.

As shown, currently, there is an urgent need for a method of providing information based on multiple dimensions; especially in an application where users query ticket information, which may provide information in multiple dimensions for the users to make travel plans.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The example embodiments of the present disclosure provide a method and apparatus for providing information, which provide information based on multiple dimensions.

In an information providing method according to an example embodiment of the present disclosure, a first user interface is provided, wherein the first user interface includes an event display region and a calendar display region, and the method comprises:

obtaining a travel destination and determining a search time period;

acquiring, according to the travel destination and the search time period, an event occurring at the travel destination in the search time period; and

displaying the first user interface, wherein information about the event is displayed in an event display region of the first user interface, and a calendar related to the search time period is displayed in a calendar display region of the first user interface.

An information providing method according to another example embodiment of the present disclosure comprises:

receiving an event acquisition request, wherein the event acquisition request includes information about a travel destination and information about a search time period;

querying, according to the travel destination and the search time period, for information about an event occurring at the travel destination in the search time period; and

sending an event acquisition response, wherein the event acquisition response includes the information about the event occurring at the travel destination in the search time period.

A client terminal device according to an example embodiment of the present disclosure comprises:

a display module configured to display the first user interface, wherein the first user interface comprises a travel destination input region;

a first acquiring module configured to obtain a travel destination according to an input operation in the travel destination input region of the first user interface, and determine a search time period;

a second acquiring module configured to acquire, according to the travel destination and the search time period, an event occurring at the travel destination in the search time period; and

the display module is further configured to display the second user interface, wherein the second user interface includes an event display region and a calendar display region, information about the event is displayed in the event display region of the second user interface, and a calendar related to the search time period is displayed in the calendar display region of the second user interface.

A server according to an example embodiment of the present disclosure comprises:

a receiving module configured to receive an event acquisition request, wherein the event acquisition request includes information about a travel destination and information about a search time period;

a query module configured to query, according to the travel destination and the search time period, for information about an event occurring at the travel destination in the search time period; and

a sending module configured to send an event acquisition response, wherein the event acquisition response includes the information about the event occurring at the travel destination in the search time period.

A client terminal device according to another example embodiment of the present disclosure includes:

a display;

a memory configured to store computer-readable instructions; and

a processor coupled to the memory, and configured to read the computer-readable instructions stored in the memory and perform the following operations in response:

displaying the first user interface by the display, wherein the first user interface includes a travel destination input region;

obtaining a travel destination according to an input operation in the travel destination input region of the first user interface, and determining a search time period;

acquiring, according to the travel destination and the search time period, an event occurring at the travel destination in the search time period; and

displaying a second user interface by the display, wherein the second user interface includes an event display region and a calendar display region, information about the event is displayed in the event display region of the second user interface, and a calendar related to the search time period is displayed in the calendar display region of the second user interface.

In the example embodiments of the present disclosure, the client terminal device may provide a first user interface, wherein the first user interface includes an event display region and a calendar display region. The client terminal device may obtain a travel destination and determine a search time period; acquire, according to the travel destination and the search time period, an event occurring at the travel destination in the search time period; and display the first user interface, wherein information about the acquired event is displayed in the event display region of the first user interface, and a calendar related to the search time period is displayed in the calendar display region. In the foregoing example embodiments, the client terminal device may acquire, according to the travel destination and the search time period, the event occurring at the travel destination in the search time period and display the acquired event in the user interface for a user, so that the user determines a travel time accordingly. Compared with the current technologies, dimensions for determining a travel plan based on events are added, so that the user conveniently determines a suitable travel plan and saves network traffic as it is unnecessary to query multiple websites, thus reducing power consumption of a terminal and resource overhead of a server.

Other example embodiments of the present disclosure further provide a method and apparatus for providing information, which provide information based on multiple dimensions.

An information providing method according to an example embodiment of the present disclosure comprises:

receiving a first search request and determining a search time period, wherein the first search request includes information about a first place and information about a second place;

acquiring, according to the information about the second place and the search time period, an event occurring at the second place in the search time period;

displaying, in a user interface, information about the event occurring at the second place in the search time period;

receiving a second search request submitted based on the user interface, wherein the second search request includes information about a first time;

acquiring associated object information according to the information about the first place, the information about the second place, and the information about the first time; and

displaying the acquired object information.

An information providing method according to another example embodiment of the present disclosure comprises:

receiving a first search request, wherein the first search request includes information about a second place and information about a search time period;

querying, according to the information about the second place and the search time period, for information about an event occurring at the second place in the search time period; and

sending a first search response, wherein the first search response includes the information about the event occurring at the second place in the search time period.

A client terminal device according to an example embodiment of the present disclosure comprises:

a first acquiring module configured to receive a first search request and determine a search time period, wherein the first search request includes information about a first place and information about a second place;

a second acquiring module configured to acquire, according to the information about the second place and the search time period, an event occurring at the second place in the search time period;

a display module configured to display, in the user interface, information about the event occurring at the second place in the search time period; and

a third acquiring module configured to receive a second search request submitted based on the user interface, wherein the second search request includes information about a first time; and acquire associated object information according to the information about the first place, the information about the second place, and the information about the first time,

wherein the display module is further configured to display the acquired object information.

A server according to an example embodiment of the present disclosure comprises:

a receiving module configured to receive a first search request, wherein the first search request includes information about a second place and information about a search time period;

a query module configured to query, according to the information about the second place and the search time period, for information about an event occurring at the second place in the search time period; and

a sending module configured to send a first search response, wherein the first search response includes the information about the event occurring at the second place in the search time period.

A client terminal device according to another example embodiment of the present disclosure comprises:

a display;

a memory configured to store computer-readable instructions; and

a processor coupled to the memory, and configured to read the computer-readable instructions stored in the memory and perform the following operations in response:

receiving a first search request and determining a search time period, wherein the first search request includes information about a first place and information about a second place;

acquiring, according to the information about the second place and the search time period, an event occurring at the second place in the search time period;

displaying, in a user interface, via the display, information about the event occurring at the second place in the search time period; and

the processor is further configured to receive a second search request submitted based on the user interface, wherein the second search request includes information about a first time; acquire associated object information according to the information about the first place, the information about the second place, and the information about the first time; and display the acquired object information via the display.

In the example embodiments of the present disclosure, the client terminal device may determine a first place, a second place, and a search time period according to a received first search request; acquire, according to information about the second place and the search time period, an event occurring at the second place in the search time period; and display the events in a user interface. The client terminal device may further receive a second search request including a first time and submitted based on the user interface, acquire associated object information according to information about the first place, the information about the second place, and information about the first time, and display the associated object information. In the foregoing example embodiments, the client terminal device may acquire, according to the second place and the search time period, the event occurring at the second place in the search time period, and display the event in the user interface for a user, so that the user determines the first time based on the events. Therefore, information is provided based on multiple perspectives such as place, time, and event.

### BRIEF DESCRIPTION OF THE DRAWINGS

In order to explain the technical solutions of the example embodiments of the present disclosure more clearly, drawings to be used for describing the example embodiments will be briefly introduced below. Apparently, the drawings described below merely represent some example embodiments of the present disclosure, and those of ordinary skill in the art may obtain other drawings according to these drawings without creative effort.

FIG. 1 is a schematic diagram of a network architecture to which an example embodiment of this example embodiment is applicable;

FIG. 2 is a schematic diagram of a user interface 200 according to an example embodiment of the present disclosure;

FIG. 3 and FIG. 4 are schematic diagrams of a user interface 300 according to an example embodiment of the present disclosure;

FIG. 5 and FIG. 6 are schematic flowcharts of an event searching process according to an example embodiment of the present disclosure;

FIG. 7 is a schematic flowchart of a ticket searching process according to an example embodiment of the present disclosure;

FIG. 8 is a schematic flowchart of a universal information providing process according to an example embodiment of the present disclosure;

FIG. 9 is a schematic structural diagram of a client terminal device according to an example embodiment of the present disclosure;

FIG. 10 is a schematic structural diagram of a server according to an example embodiment of the present disclosure;

FIG. 11 is a schematic structural diagram of a client terminal device according to another example embodiment of the present disclosure;

FIG. 12 is a schematic structural diagram of a server according to another example embodiment of the present disclosure;

FIG. 13 is a schematic structural diagram of a client terminal device according to another example embodiment of the present disclosure; and

FIG. 14 is a schematic structural diagram of a client terminal device according to another example embodiment of the present disclosure.

### DETAILED DESCRIPTION

In order to solve the problem in the current technologies that a user needs to visit multiple websites to determine a travel time (which may include a departure time and/or a return time) when a travel destination has been determined, example embodiments of the present disclosure provide a method and apparatus for providing information, which may be applied in an e-commerce website. Using an application related to ticket information querying and booking as an example, in the application, a client terminal device may acquire, according to a designation and a search time period input by a user, an event going to occur at the destination in the search time period, and display the acquired event and a calendar related to the search time period in a user interface. An occurrence time of the corresponding event may be marked in the calendar, so that the user may learn the event going to occur at the destination in the search time period and the specific occurrence time of the event according to the user interface, thereby determining a travel time according to his/her own requirement and preference.

The example embodiments of the present disclosure are described in detail below with reference to the accompanying drawings by using an application related to travel ticket information querying as an example. It should be understood that the example embodiments described here are merely for describing and illustrating the present disclosure, rather than limiting the present disclosure. Moreover, the example embodiments in the present disclosure and features in the example embodiments may be combined with each other if no conflict occurs.

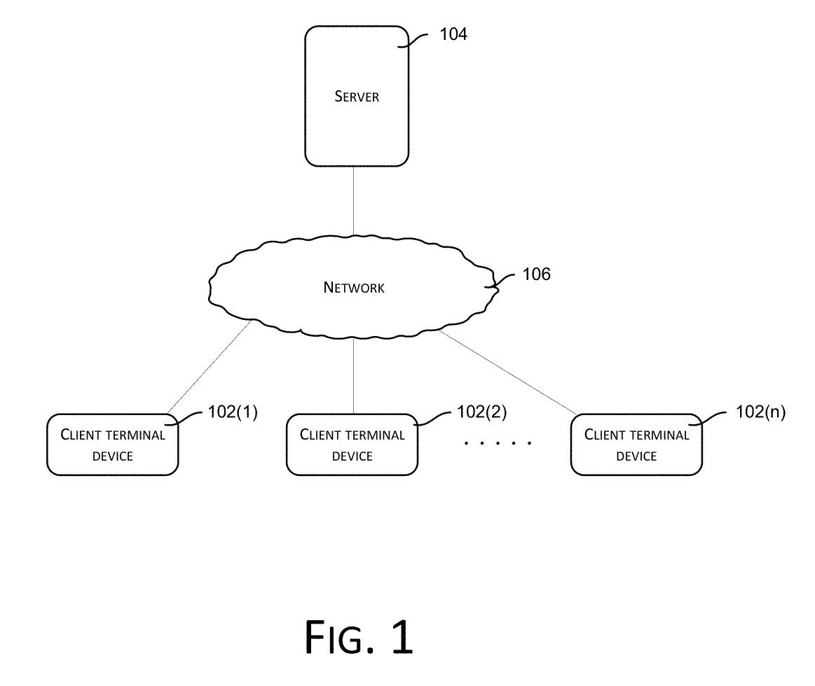

FIG. 1 exemplarily shows a schematic diagram of a network architecture to which an example embodiment of the present disclosure is applicable. As shown in FIG. 1, the network architecture may include one or more client terminal devices 102(1), 102(2), . . . 102(n), wherein n may be any integer, and a server 104. There may be multiple client terminal devices 102 and multiple servers 104 (only one is shown in the figure). The client terminal device 102 and the server 104 may communicate with each other through a network 106.

The client terminal device 102 in the architecture is provided with a client terminal program for providing information, and the server 104 is provided with a server terminal program for providing information. The client terminal device 102 and the server 104 may cooperate with each other to implement functions and services related to information providing.

The client terminal device 102 in the network architecture may be a device such as a mobile terminal, a personal computer (PC), or the like. The mobile terminal may be a mobile phone, a Personal Digital Assistant (PDA), a smart wearable device, or the like.

The client terminal device 102 and the server 104 in the network architecture may perform information interaction through the network 106. The network may be a wide area network, a local area network or the Internet, or the Internet using a mobile communication technology. The client terminal device 102 may access the Internet in a wireless manner, and the server 104 is usually connected to the Internet in a wired manner.

For example, the client terminal device 102 and the server 104 may adopt a cloud computing technology to implement information processing based on powerful functions of the cloud computing technology. The client terminal device 102 and the server 104 may adopt an operating system based on the cloud computing technology, such as YunOS, thereby integrating resources and services of the cloud and terminals.

In the example embodiment of the present disclosure, an event database for storing event information may be preset, the event information specifically may include event themes, event descriptive information, event occurrence times and places, and the like. The database may provide a query service. For example, the event database may be queried based on a place and a time, to obtain an event occurring at the place at the time. The “event” here includes various events in social life, for example, holiday activities, performance activities (such as concerts), sports events (such as an opening ceremony of games, matches, and other activities), and so on, which are not elaborated here. The various events may be categorized into two types according to characteristics thereof On type is fixed-type events, for example, a holiday event is generally held on the holiday, and some sports games also has this characteristic. The other type is non-fixed-type events, for example, performance activities.

In example embodiments of the present disclosure, the event database is set in the server. The event database set in the server may be updated according to requirements. The client terminal device may send an event query request to the server, thereby obtaining event-related information.

In other example embodiments, the event database may be set in the client terminal device. The client terminal device may send an event database update request to the server, to update the local event database. The server may also proactively push database update information to the client terminal device when there is a new event arrangement (for example, it is confirmed that a new concert will be held one month later), to update the event database of the client terminal device.

In other example embodiments, event databases may be set in the client terminal device and the server respectively. The event database disposed in the client terminal device is a database of fixed-type events, and the database set in the server is a database of non-fixed-type events. It is generally unnecessary to update the fixed-type events. Therefore, the database of fixed-type events is set in the client terminal device, so that signaling interaction between the client terminal device and the server for updating the event database may be avoided. The server may update the database of non-fixed-type events therein according to requirements. The client terminal device may send an event query request to the server, to obtain information related to a non-fixed-type event.

As shown from the three event database setting methods above, if an event database is only set in the client terminal device, the client terminal device may query for event-related information efficiently, but needs to interact with the server to update the event database. If an event database is set only in the server, it is unnecessary to exchange signaling for updating the database with the client terminal device, but the client terminal device needs to interact with the server when querying the database. If databases of different types of events are set in the client terminal device and the server respectively, a balance may be achieved between the access efficiency and resource overhead. During the specific implementation, a suitable setting method may be selected according to an access performance requirement, a device storage overhead requirement, network performance, and other factors.

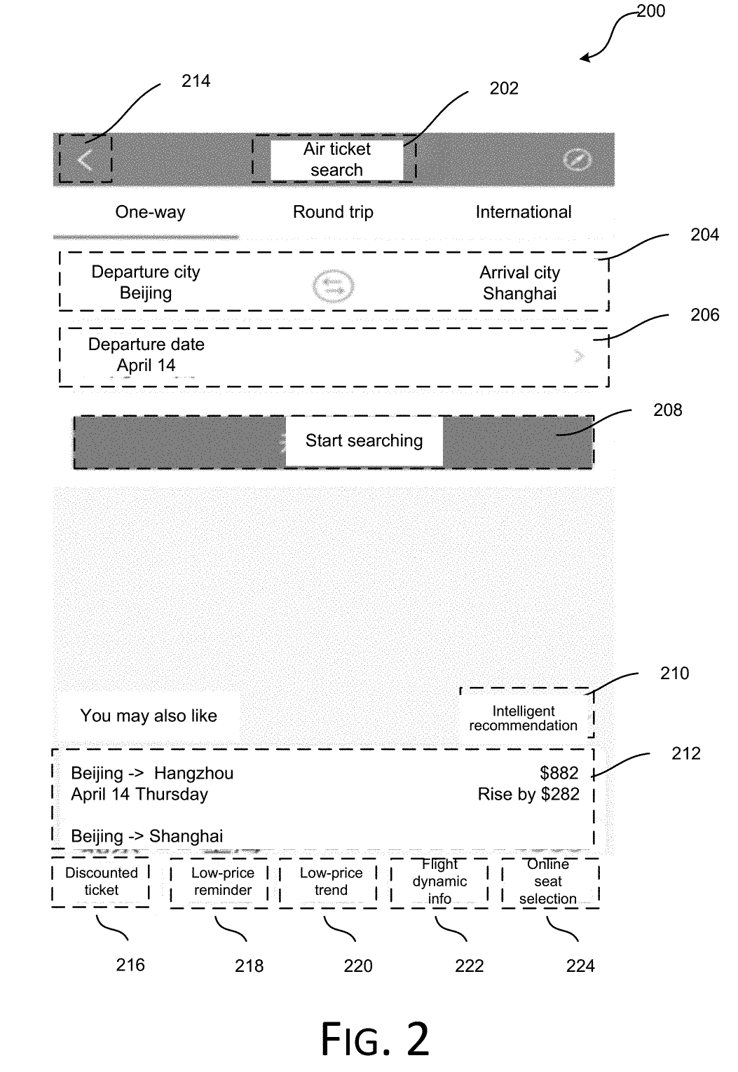

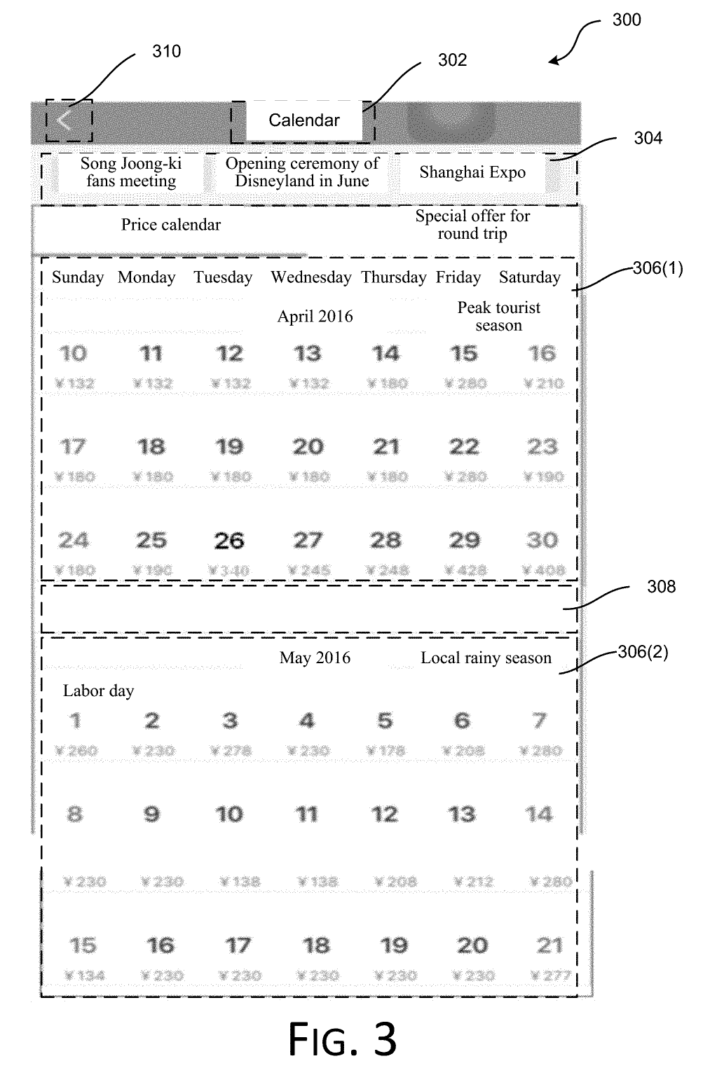

The client terminal device may provide a user interface for event and ticket information querying. FIG. 2 exemplary shows a user interface 200 allowing a user to input a query condition. FIG. 3 exemplary shows a user interface 300 for displaying found events and a related calendar.

As shown in FIG. 2, the user interface 200 may include an interface theme display region 202, a travel place input region 204, a travel time input region 206, and a search instruction region 208. “Air ticket search” is displayed in the interface theme display region 202 as a theme name of the user interface. The travel place input region 204 provides an input region for a place of departure and an input region for a place of arrival. The travel place input region 204 may be implemented by an input field control, which allows a user to input a travel place; or the travel place input region 202 may be implemented by another control, for example, a pop-up city selection interface presented when a user clicks the input region for a place of departure, which allows the user to select a city in the program selection interface as a place of departure. The travel time input region 206 may be implemented by an input field control, which allows a user to input a departure time; or the travel time input region 206 may be implemented by another control, for example a pop-up calendar presented when the user clicks a departure time input region, which allows the user to select a departure time in the calendar. The search instruction region 208 may be implemented by using a button control or a link. When the user selects a query instruction, an event query request including information about a travel place and a travel time is generated.

Further, the user interface may further include an intelligent recommendation selection instruction region 210. A user may click the intelligent recommendation selection instruction region 210 to switch between unfolding an intelligent recommendation information window 212 and closing the intelligent recommendation window 212, wherein the intelligent recommendation information window 212 may display system-recommended ticket information for traveling from a place of departure to a travel destination.

Further, the user interface may further include some shortcut operation regions to facilitate operations, for example, a shortcut operation region 214 for returning to a previous user interface, a shortcut operation region 216 for skipping to a discounted air ticket querying interface, a shortcut operation region 218 for skipping to an interface for displaying low price reminder information, a shortcut operation region 220 for skipping to a low price trend querying interface, a shortcut operation region 222 for skipping to an interface for displaying flight dynamic information, and a shortcut operation region 224 for skipping to an online seat selection interface.

After inputting the travel place and travel time in the user interface 200 and selecting a search instruction, the user may be redirected to the user interface 300.

As shown in FIG. 3, the user interface 300 may include an interface theme display region 302, an event label display region 304, and a calendar display region including 306(1) and 306(2), and may further include an event descriptive information display region 308. The event label display region 304 and the event descriptive information display region 308 may be collectively referred to as an event information display region.

“Calendar” is displayed in the interface theme display region 302 as a theme name of the user interface. The event label display region 304 displays event-related information acquired based on the travel place and travel time input in the user interface 200. One event label may correspond to one event, and a theme of the event may be shown on the label. One event label may also correspond to multiple events. The calendar display region 306 displays a calendar related to the travel time input in the user interface 200. For example, if the travel times is Apr. 14, 2016, the calendar displayed in the calendar display region 306 is a calendar of April and May in 2016.

Further, on the calendar displayed in the calendar display region 306, an air ticket price may be displayed corresponding to each date. An air ticket price corresponding to a date is an air ticket price (for example, the air ticket price may be an average price, a lowest price, or a highest price) on the date obtained based on the travel place input through the user interface 200. For example, the place of departure and the destination input through the user interface 200 are Beijing and Shanghai, an air ticket price corresponding to Apr. 14, 2016 on the calendar displayed in the calendar display region 306 may be an average price of air tickets of all flights from Beijing to Shanghai on Apr. 14, 2016

Further, some other travel-related information of the travel destination in the corresponding period may be displayed in the calendar display region 306 based on the displayed calendar. For example, one or more of the following types of information are displayed: climate information about whether the travel destination is in a rainy season or the like, weather information, information about whether the travel destination is in a peak tourist season, and so on.

Further, the user interface may further include some shortcut operation regions for facilitating operations, for example, a shortcut operation region 310 for returning to a previous user interface.

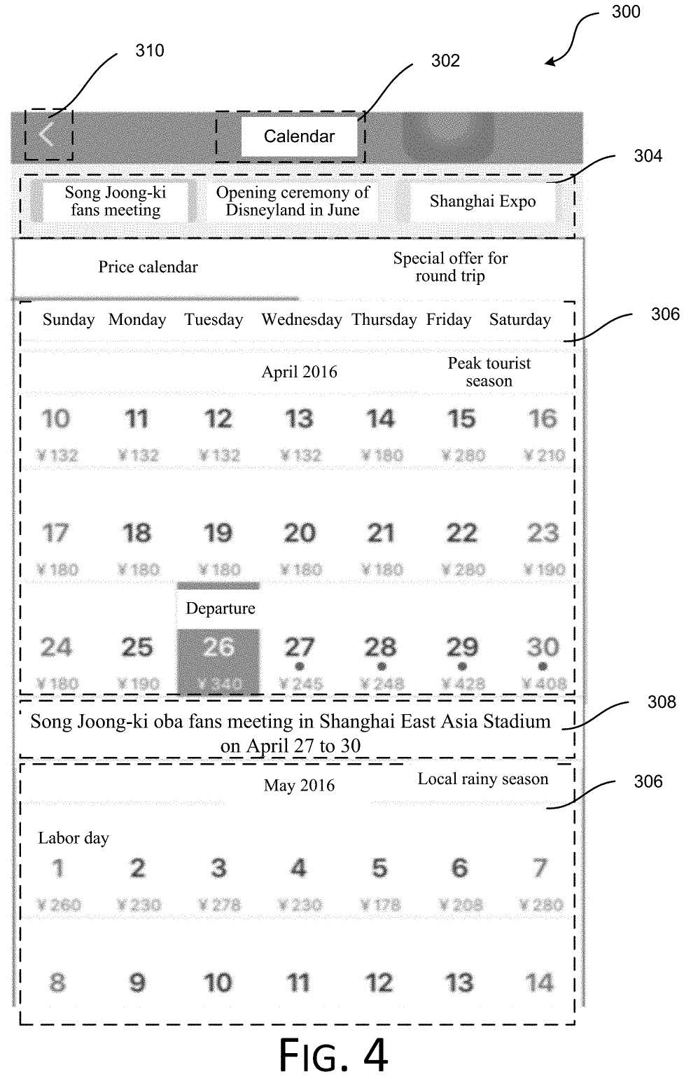

After a user selects an event label through an operation on a screen, the user interface 300 may be as shown in FIG. 4. According to an event corresponding to the selected event label, a calendar related to an occurrence time of the event is displayed in the calendar display region 306. For example, if the occurrence time of the event selected by the user is Apr. 26, 2016, a calendar of April in 2016 is displayed in the calendar display region 306. For another example, if the occurrence time of the event selected by the user is from Apr. 25, 2016 to May 5, 2016, a calendar of April and May in 2016 is displayed in the calendar display region 306. According to the calendar corresponding to the selected event label, descriptive information of the event is displayed in the event descriptive information display region 308, e.g., a brief introduction or description of the event. The event descriptive information may be displayed in many media forms, such as a text, a picture, and the like. The event descriptive information may include a link for skipping to a page for describing the corresponding event. When the link is selected, the page for introducing the corresponding event is opened.

The user may obtain, according to the user interface 300 shown in FIG. 4, multi-dimensional information related to the travel time and the travel place, e.g., including event information, air ticket price information, local climate information, local weather information, and the like, so that the user is provided with a multi-dimensional information service for making a travel plan. Based on the foregoing information, the user may determine a final travel time (such as a departure date and a return date) through the calendar provided in the user interface 300, and may generate a ticket search request based on the selected travel time and send the ticket search request to the server, to query for corresponding ticket information.

It should be noted that the travel time input in the user interface 200 is mainly used as an event search condition for searching for an event in a corresponding period and display the event in the user interface 300, thereby providing a basis for the user to determine a final travel time. The time input by the user based on the user interface 300 is used as a final travel time for searching for ticket information, and the ticket information is displayed to the user.

It should be noted that the user interface 200 and the user interface 300 are merely examples. The example embodiment of the present disclosure is not limited to the user interface shown in FIG. 2 and FIG. 3. For example, the event information may be displayed in the user interface with a label, or displayed in the user interface in other forms, such as a title list, which are not enumerated here.

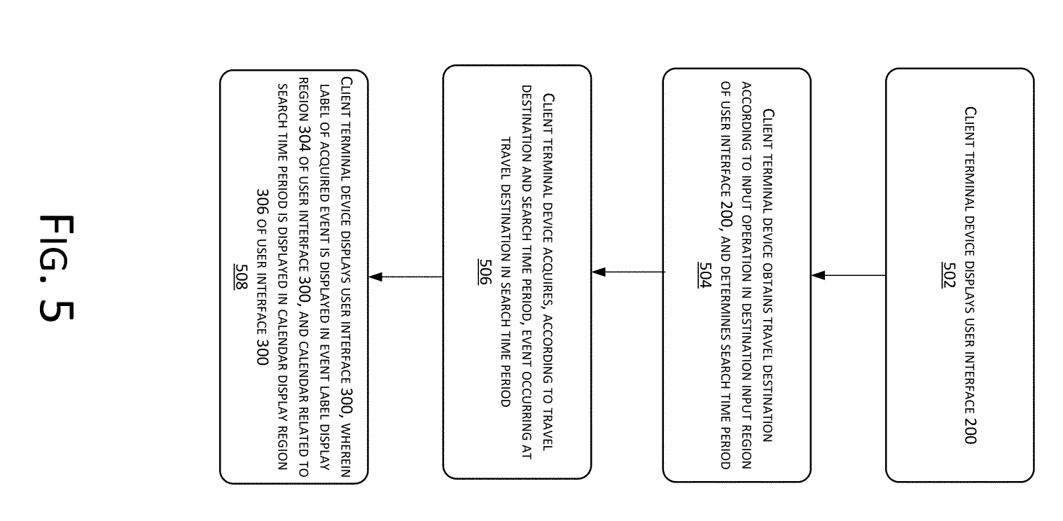

FIG. 5 shows a schematic flowchart of an information providing process implemented based on the user interface 200 and the user interface 300 above. As shown in FIG. 5, the process may include the following steps.

Step 502: A client terminal device displays the user interface 200.

In this step, a user may perform an operation on a screen (for example, clicking a link for querying ticket information), so that the client terminal device displays the user interface 200. Before the user inputs information about a travel time and a travel place in the user interface 200, the travel place input region 202 in the user interface 200 is empty by default, or the current city where the user is located is displayed by default in an input region for a place of departure in the travel place input region 202. Considering that a value of the current IP address is related to a geographical region, the current city of the user may be determined according to the current IP address used by the client terminal device. The travel time input region 203 of the user interface 200 may be empty by default, or display the current date according to the current system time of the client terminal device.

Step 504: The client terminal device obtains a travel destination according to an input operation in the destination input region of the user interface 200, and determines a search time period.

In this step, the user may input a travel destination in the travel place input region 202 of the user interface 200. As described above, according to different types of controls used in this region, the user may input travel destination information in corresponding manners. For example, if the travel place input region 202 uses an input field control, the user needs to input the travel destination in the input field. If the travel place input region 202 uses a pop-up window to display names of cities, the user may click the name of a corresponding city to select the city as the travel destination.

Based on the user interface 200, the client terminal device may use a date input by the user in the travel time input region 203 of the user interface 200 as the search start date of the search time period, and determine the search end date of the search time period according to the search start date and a default search time length, thereby determining the search time period.

In other example embodiments, the search time period may also be determined using the following methods.

In method 1, the search start date of the search time period is determined according to the current system time, and the search end date of the search time period is determined according to the determined search start date and a default search time length. This method is applicable to the case where the user interface does not include a travel time input region.

In method 2, the search start date of the search time period is determined according to the current system time, and a travel time input in the user interface 200 is used as the search end date of the search time period, thereby determining the search time period.

In method 3, a travel start date input in the travel date input region 203 of the user interface 200 is sued as the search start date of the search time period, and a travel return date input in this region is used as the search end date of the search time period, thereby determining the search time period.

Step 506: The client terminal device acquires, according to the travel destination and the search time period, an event occurring at the travel destination in the search time period.

In this step, according to different event database setting methods, event information may be acquired in a corresponding manner. For example, the event information may be acquired in the following manners.

In manner 1, the client terminal device queries a preset event database according to the travel destination and the search time period to obtain information about an event occurring at the travel destination in the search time period. This manner is applicable to the case where the event database is set only in the client terminal device.

In manner 2, the client terminal device sends an event acquisition request to the server, wherein the event acquisition request includes information about the travel destination and information about the search time period. The server queries an event database according to the information about the travel destination and the information about the search time period in the event acquisition request, to obtain an event occurring at the travel destination in the search time period, and return the event to the client terminal device through an event acquisition response. This manner is applicable to the case where the event database is set only in the server.

In manner 3, on one hand, the client terminal device queries a preset event database according to the travel destination and the search time period, to obtain information about a first-type event (a fixed-type event) occurring at the travel destination in the search time period. On the other hand, the client terminal device sends an event acquisition request to the server, wherein the event acquisition request includes information about the travel destination and information about the search time period. The server queries an event database according to the information about the travel destination and the information about the search time period in the event acquisition request, to obtain a second-type event occurring at the travel destination in the search time period, and return the second-type event to the client terminal device through an event acquisition response. The client terminal device obtains, according to information about the first-type event and information about the second-type event, information about the event occurring at the travel destination in the search time period. This manner is applicable to the case where an event database of first-type events is set in the client terminal device and an event database of second-type events is set in the server.

Many events or many types of events may occur at the travel destination in the search time period, and not all types of events are concerned by the user. Therefore, to make the found events meet the requirement or preference of the user, in this step, after the events occurring at the travel destination in the search time period are found, the events may further be screened according to user preference information, so that event matching the user preference information is displayed in the user interface. During implementation, before using the application related to ticket information querying, the user first needs to log onto a corresponding system with a user account. Therefore, in step 506, the client terminal device may send a user preference information acquisition request to the server, where the request carries user account information (such as a user ID). The server may acquire corresponding user reference information according to the user account information and return the user reference information to the client terminal device. The client terminal device may also query, according to the user account information, cookie information saved in the client terminal device to obtain user preference information. For example, the client terminal device judges according to the user preference information that the user is more interested in sports events than in concerts. Therefore, concert events in the found events may be removed by filtering, and sports events are reserved to be displayed in an event label.

Step 508: The client terminal device displays the user interface 300, wherein a label of the acquired event is displayed in the event label display region 304 of the user interface 300, and a calendar related to the search time period is displayed in the calendar display region 306 of the user interface 300. Details are as shown in FIG. 3.

In this step, when event labels are displayed, events to be displayed may be sorted according to a descending order of priority levels, and labels of the corresponding events are displayed according to the sorted events. The order of priority levels may be set by the user or the system. In an example where the order of priority levels is set by the system, a priority level of sports events is higher than that of concerts. In another example, after obtaining the user preference information, the client terminal device may determine priority levels of different types of events according to the user preference information. For example, if the user preference information indicates that the user is more interested in concert events than in sports events, the priority level of the concert events may be set to be higher than that of the sports events.

In the foregoing process, the client terminal device first receives an event query request (the request includes information about a travel destination and information about a search time period) based on the user interface 200, and then displays information about found events through the user interface 300. In other examples, the event query request may also be obtained in other manners. For example, when an application for introducing tourism information is run, a user inputs destination information and expected travel time information. A user interface of the application for receiving tourism information includes a link for ticket querying. When the user selects the link, a Uniform Resource Identifier (URI) request carrying the input destination information and expected travel time information as a parameter may be sent to the server. The server may query for related event information according to the parameter, and return, to the client terminal device, the user interface 300 of the application that provides the ticket information querying service. The user interface 300 displays related information of found events.

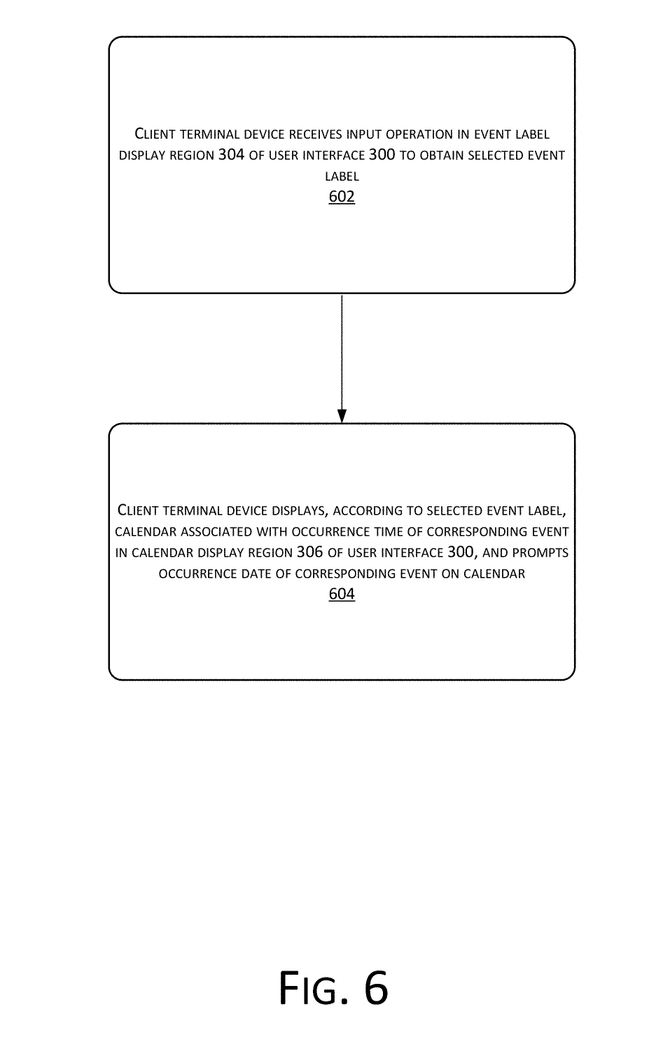

Further, after step 508, the user may select an event label to view specific information of a corresponding event. As shown in FIG. 6, this process may include the following steps.

Step 602: The client terminal device receives an input operation in the event label display region 304 of the user interface 300 to obtain a selected event label.

Step 604: The client terminal device displays, according to the selected event label, a calendar associated with an occurrence time of a corresponding event in the calendar display region 306 of the user interface 300, and prompts an occurrence date of the corresponding event on the calendar. For example, the occurrence time of the event (including an event start date, or an event end date, or a period from the event start date to the event end date) may be displayed prominently on the calendar, for example, highlighted or displayed in a different color. Further, an occurrence time period of an event may be extended to M days before (the value of M may be set, for example, the value is 1 or 2), and a start date of the extended period is displayed prominently in the calendar as a travel time start date recommended to the user.

Further, after obtaining the selected event label, the client terminal device may further display descriptive information of the corresponding event in the event descriptive information display region 308 according to the selected event label. The event descriptive information displayed in this region may be displayed with a text, a picture, or another type of media, or with a combination of multiple types of media.

A display effect may be as shown in FIG. 4.

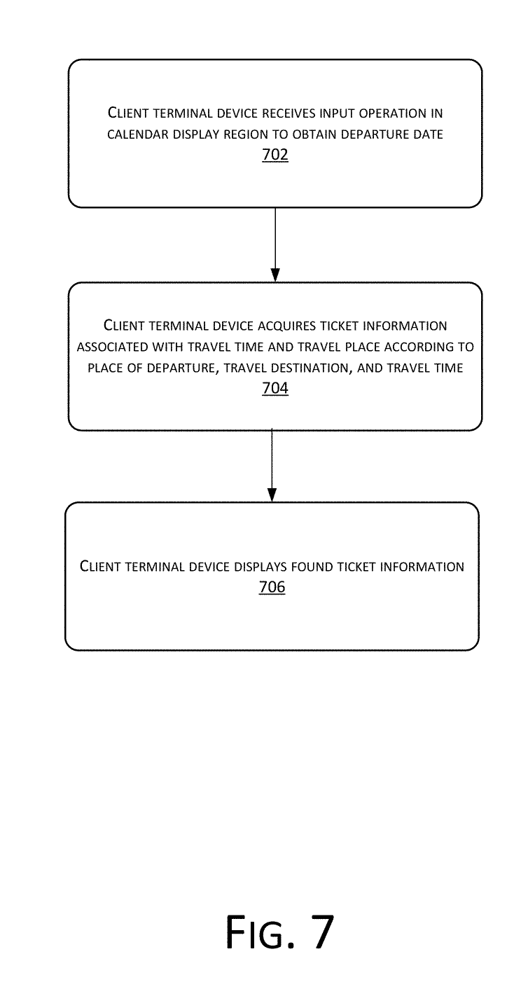

Further, after step 508 or step 604, the user may select a specific travel date (including a departure date, or including a departure date and a return date) based on the information displayed in the user interface 300, so that ticket information of the corresponding date is found by querying based on the travel date and then displayed. As shown in FIG. 7, the process may include the following steps.

Step 702: The client terminal device receives an input operation in the calendar display region to obtain a departure date.

In this step, the user may determine a final travel time based on multi-dimensional information displayed in the user interface 300. The user may select a date on the calendar displayed in the calendar display region, so that the client terminal device obtains a travel time (including a departure date, including a return date, or including the departure date and the return date). Of course, the example embodiment of the present disclosure also allows the user to input the travel time in other manners.

Step 704: The client terminal device acquires ticket information associated with a travel time and a travel place according to a place of departure, a travel destination, and the travel time.

Specifically, the acquired ticket information may include one type of the following information: ticket information for traveling from the place of departure to the travel destination on the departure date, and ticket information for traveling from the travel destination back to the place of departure on the return date.

In this step, the client terminal device may send a ticket information query request to the server, wherein the request carries a place of departure, information about a travel destination, and information about a travel time. The server queries for ticket information according to the query request, and returns the found ticket information to the client terminal device.

Step 706: The client terminal device displays the found ticket information. The displayed ticket information may include an airline name, a flight name, a departure time, an arrival time, a price, special offer information, and the like.

It may be learned from the foregoing description that, in the foregoing example embodiment of the present disclosure, the client terminal device may provide a first user interface, wherein the first user interface includes an event display region and a calendar display region. The client terminal device may obtain a travel destination and determine a search time period; acquire, according to the travel destination and the search time period, an event occurring at the travel destination in the search time period; and display the first user interface, wherein information about the acquired event is displayed in the event display region of the first user interface, and a calendar related to the search time period is displayed in the calendar display region. In the foregoing example embodiment, the client terminal device may acquire, according to the travel destination and the search time period, the event occurring at the travel destination in the search time period and display the acquired event in the user interface for a user, so that the user determines a travel time based on the event. Compared with the current technologies, dimensions for determining a travel plan based on an event are increased, so that the user may conveniently determine a suitable travel plan, and may save network traffic as it is unnecessary to query multiple websites, thus reducing power consumption of a terminal and resource overhead of a server.

Based on the basically same technical conception, another example embodiment of the present disclosure further provides a universal information providing method.

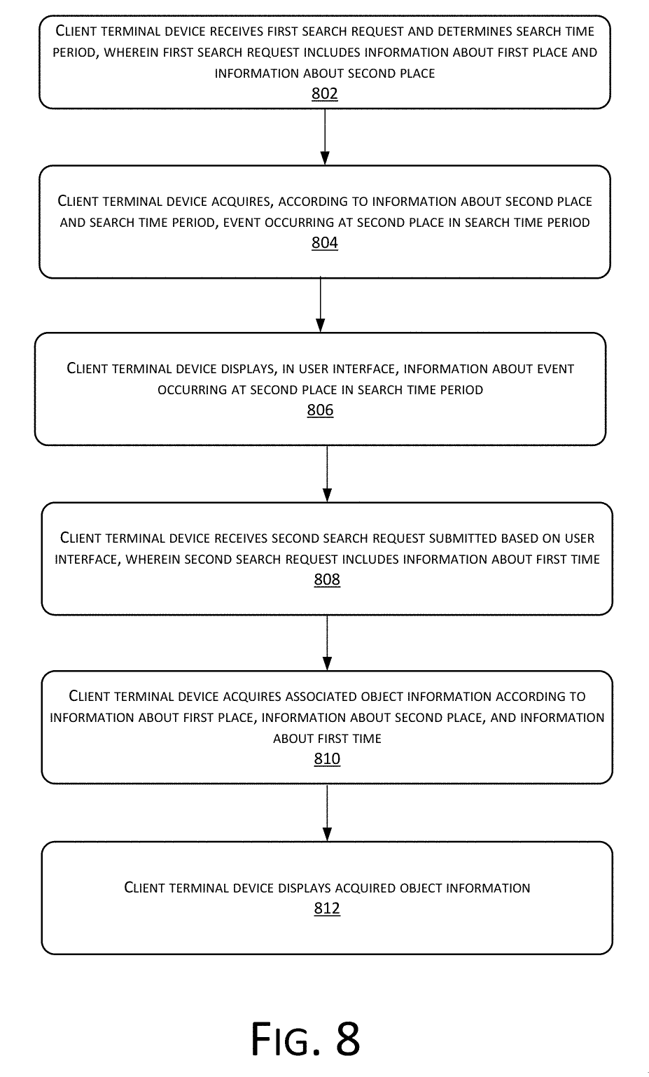

Referring to FIG. 8, a schematic flowchart of a universal information providing process according to an example embodiment of the present disclosure is shown. As shown in the drawing, this process may include the following steps.

Step 802: A client terminal device receives a first search request and determines a search time period, wherein the first search request includes information about a first place (such as a place of departure) and information about a second place (such as a travel destination).

Step 804: The client terminal device acquires, according to the information about the second place and the search time period, an event occurring at the second place in the search time period.

This step may be implemented in the following manners.

In manner 1, the client terminal device queries preset information according to the information about the second place and the search time period to obtain information about an event occurring at the travel destination in the search time period. The preset information includes event(s) occurring at N place(s) and occurrence time(s) of the event(s), and N is an integer greater than or equal to 1

In manner 2, the client terminal device sends an event acquisition request to the server, wherein the event acquisition request includes the information about the second place and information about the search time period. The server sends an event acquisition response according to the event acquisition request, wherein the event acquisition response includes information about the event occurring at the second place in the search time period acquired by the server according to the information about the second place and the search time period.

In manner 3, on one hand, the client terminal device queries preset information according to the information about the second place and the search time period, to obtain information about a first-type event occurring at the second place in the search time period. On the other hand, the client terminal device sends an event acquisition request to the server, wherein the event acquisition request includes the information about the second place and information about the search time period. The client terminal device receives an event acquisition response sent by the server according to the event acquisition request, wherein the event acquisition response includes information about a second-type event occurring at the second place in the search time period acquired by the server according to the information about the second place and the search time period.

Further, the server may further acquire user preference information, and filter, according to the user preference information, the event occurring at the second place in the search time period.

Step 806: The client terminal device displays, in a user interface, information about the event occurring at the second place in the search time period.

The user interface may include an event label display region and a calendar display region. In this step, the client terminal device may display, in the event label display region of the user interface, a theme of the event occurring at the second place in the search time period with a label, and one event label corresponds to one or more events. A calendar related to the search time period is displayed in the calendar display region of the user interface.

Further, after step 806, the client terminal device may receive an input operation of the user in the event label display region of the user interface, to obtain a selected event label; display, according to the selected event label, a calendar associated with an occurrence time of a corresponding event in the calendar display region of the user interface; and prompt an occurrence date of the corresponding event on the calendar, or display a recommended travel date on the calendar according to the occurrence date of the corresponding event.

Further, the event display region of the user interface further includes an event descriptive information display region. Correspondingly, after obtaining the selected event label, the client terminal device may further display descriptive information of a corresponding event in the event descriptive information display region according to the selected event label.

Step 808: The client terminal device receives a second search request submitted based on the user interface, wherein the second search request includes information about a first time (such as a departure date).

Step 810: The client terminal device acquires associated object information (such as ticket information for traveling from the place of departure to the travel destination on the departure date) according to the information about the first place, the information about the second place, and the information about the first time

In this step, the client terminal device may send a search request for acquiring object information to the server, where the second search request includes the information about the first place, the information about the second place, and the information about the first time. The server may query for associated object information according to the information about the first place, the information about the second place, and the information about the first time, and return a search response to the client terminal device, wherein the search response includes the found object information.

Step 812: The client terminal device displays the acquired object information.

It may be learned from the description above that in the foregoing example embodiment of the present disclosure, the client terminal device may determine a first place, a second place, and a search time period according to a received first search request; acquire, according to information about the second place and the search time period, an event occurring at the second place in the search time period; and display the event in a user interface. The client terminal device may further receive a second search request including a first time and submitted based on the user interface, acquire associated object information according to information about the first place, the information about the second place, and information about the first time, and display the associated object information. In the foregoing example embodiment, the client terminal device may acquire, according to the second place and the search time period, the event occurring at the second place in the search time period, and display the event in the user interface for a user, so that the user determines the first time based on the event. Therefore, information is provided based on multiple perspectives such as place, time, and event.

Based on the same technical conception, an example embodiment of the present disclosure further provides a client terminal device.

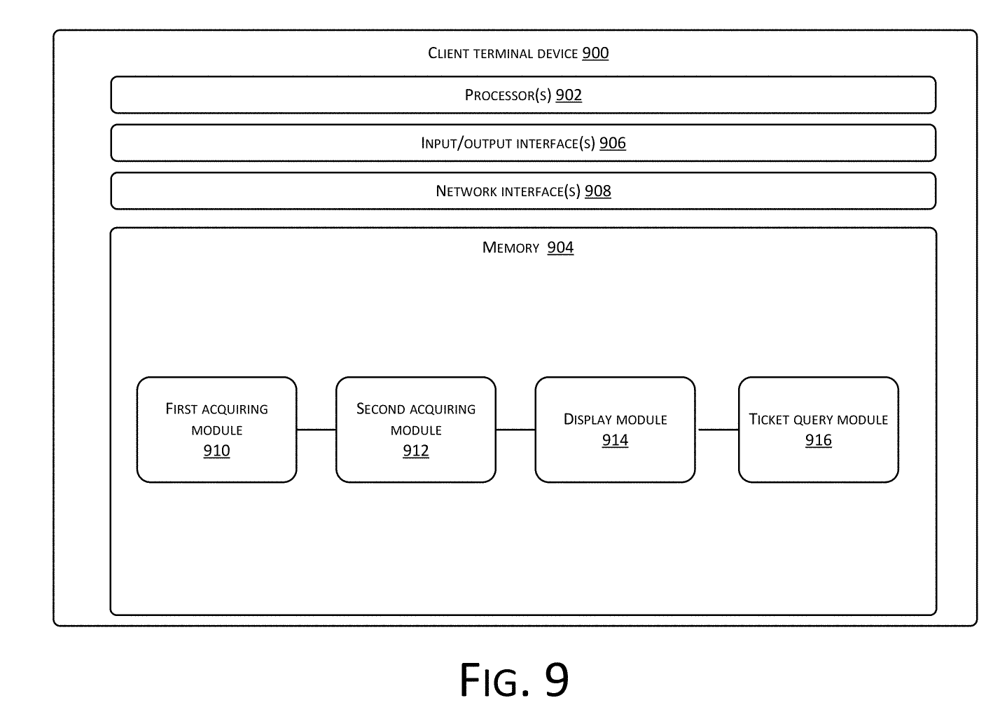

Referring to FIG. 9, a schematic structural diagram of a client terminal device according to an example embodiment of the present disclosure is shown. The device may implement the information providing process provided in the foregoing example embodiment. As shown FIG. 9, a client terminal device 900 may include one or more processor(s) 902 or data processing unit(s) and memory 904. The client terminal device 900 may further include one or more input/output interface(s) 906 and one or more network interface(s) 908. The memory 904 is an example of computer readable medium or media.

The computer readable medium includes non-volatile and volatile media as well as movable and non-movable media, and may store information by means of any method or technology. The information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as a modulated data signal and a carrier.

The memory 904 may store therein a plurality of modules or units including a first acquiring module 910, a second acquiring module 912, and a display module 914, and may further include a ticket query module 916.

The first acquiring module 910 is configured to obtain a travel destination and determine a search time period.

The second acquiring module 912 is configured to acquire, according to the travel destination and the search time period, an event occurring at the travel destination in the search time period.

The display module 914 is configured to display the first user interface, wherein the first user interface includes an event display region and a calendar display region, information about the event is displayed in the event display region of the first user interface, and a calendar related to the search time period is displayed in the calendar display region of the first user interface.

For example, the second acquiring module 912 may be configured to query preset information according to the travel destination and the search time period to obtain information about the event occurring at the travel destination in the search time period, wherein the preset information includes event(s) occurring at N place(s) and occurrence time(s) of the event(s), and N is an integer greater than or equal to 1.

For example, the second acquiring module 912 may be configured to send an event acquisition request to a server, wherein the event acquisition request includes information about the travel destination and information about the search time period; and receive an event acquisition response sent by the server according to the event acquisition request, wherein the event acquisition response includes information about the event occurring at the travel destination in the search time period acquired by the server according to the travel destination and the search time period.

For example, the second acquiring module 912 may be configured to query preset information according to the travel destination and the search time period to obtain information about first-type event(s) occurring at the travel destination in the search time period, wherein the preset information includes first-type event(s) occurring at N travel destination(s) and occurrence time(s) of the first-type event(s), and N is an integer greater than or equal to 1; send an event acquisition request to a server, wherein the event acquisition request includes information about the travel destination and information about the search time period, and receive an event acquisition response sent by the server according to the event acquisition request, wherein the event acquisition response includes information about second-type event(s) occurring at the travel destination in the search time period acquired by the server according to the travel destination and the search time period; and obtain, according to the information about the first-type event(s) and the information about the second-type event(s), information about the event occurring at the travel destination in the search time period.

For example, the second acquiring module may be further configured to acquire user preference information, and filter, according to the user preference information, the event occurring at the travel destination in the search time period. Correspondingly, when displaying the first user interface, the display module 914 may be further configured to display information about the filtered event in the event display region of the first user interface.

For example, the event display region of the first user interface includes an event label display region for displaying a theme of the event occurring at the travel destination in the search time period with a label, and one event label corresponds to one or more events. Correspondingly, the display module 914 may be further configured to receive an input operation in the event label display region of the first user interface to obtain a selected event label; display, according to the selected event label, a calendar associated with an occurrence time of a corresponding event in the calendar display region of the first user interface; and prompt an occurrence date of the corresponding event on the calendar, or display a recommended travel date on the calendar according to the occurrence date of the corresponding event.

For example, the ticket query module 916 is configured to receive an input operation in the calendar display region to obtain a departure date; and obtain ticket information for traveling from a place of departure to the travel destination on the departure date according to the place of departure, the travel destination, and the departure date. Correspondingly, the display module 914 may be further configured to display the ticket information.

Based on the same technical conception, an example embodiment of the present disclosure further provides a server.

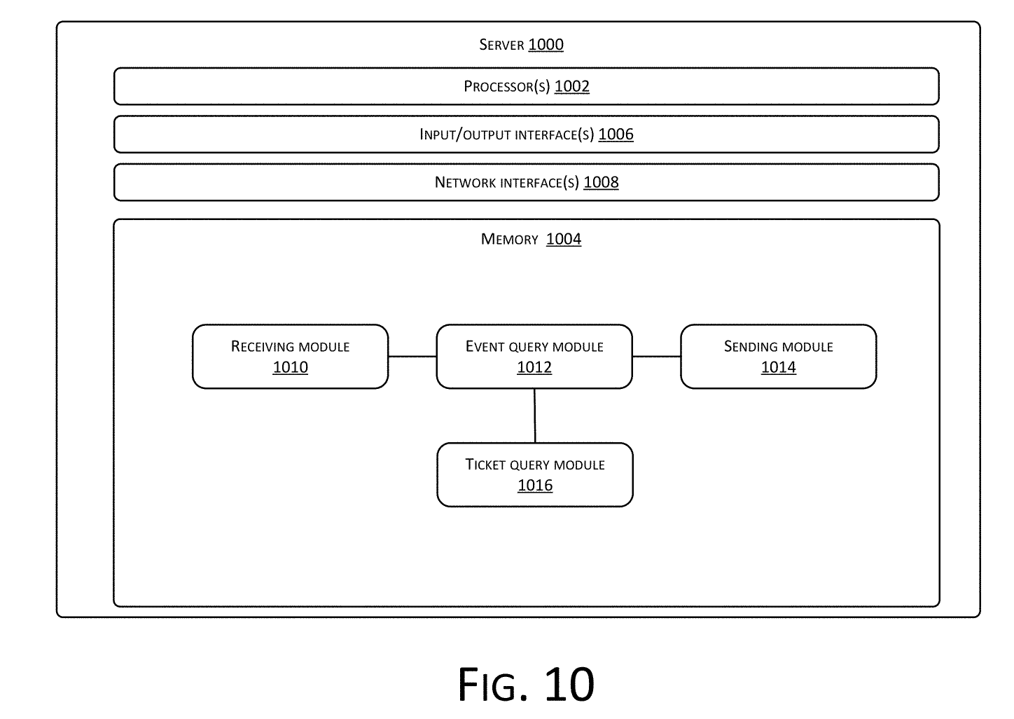

Referring to FIG. 10, a schematic structural diagram of a server according to an example embodiment of the present disclosure is shown. The server may implement the information providing process described in the foregoing example embodiment. As shown in FIG. 10, a server 1000 may include one or more processor(s) 1002 or data processing unit(s) and memory 1004. The server 1000 may further include one or more input/output interface(s) 1006 and one or more network interface(s) 1008. The memory 1004 is an example of computer readable medium or media.

The memory 1004 may store therein a plurality of modules or units including a receiving module 1010, an event query module 1012, and a sending module 1014, and may further include a ticket query module 1016.

The receiving module 1010 is configured to receive an event acquisition request, wherein the event acquisition request includes information about a travel destination and information about a search time period.

The event query module 1012 is configured to query, according to the travel destination and the search time period, for information about an event occurring at the travel destination in the search time period.

The sending module 1014 is configured to send an event acquisition response, wherein the event acquisition response includes the information about the event occurring at the travel destination in the search time period.

For example, the event query module 1012 is further configured to acquire user preference information; and filter, according to the user preference information, the event occurring at the travel destination in the search time period.

For example, the receiving module 1010 is further configured to receive a ticket information query request, wherein the ticket information query request includes a place of departure, the travel destination, and a departure date. The ticket query module 1016 is configured to query for ticket information for traveling from the place of departure to the travel destination on the departure date according to the place of departure, the travel destination, and the departure date. The sending module 1014 is further configured to send a ticket information query response, wherein the ticket information query response includes the found ticket information.

Based on the same technical conception, an example embodiment of the present disclosure further provides a client terminal device.

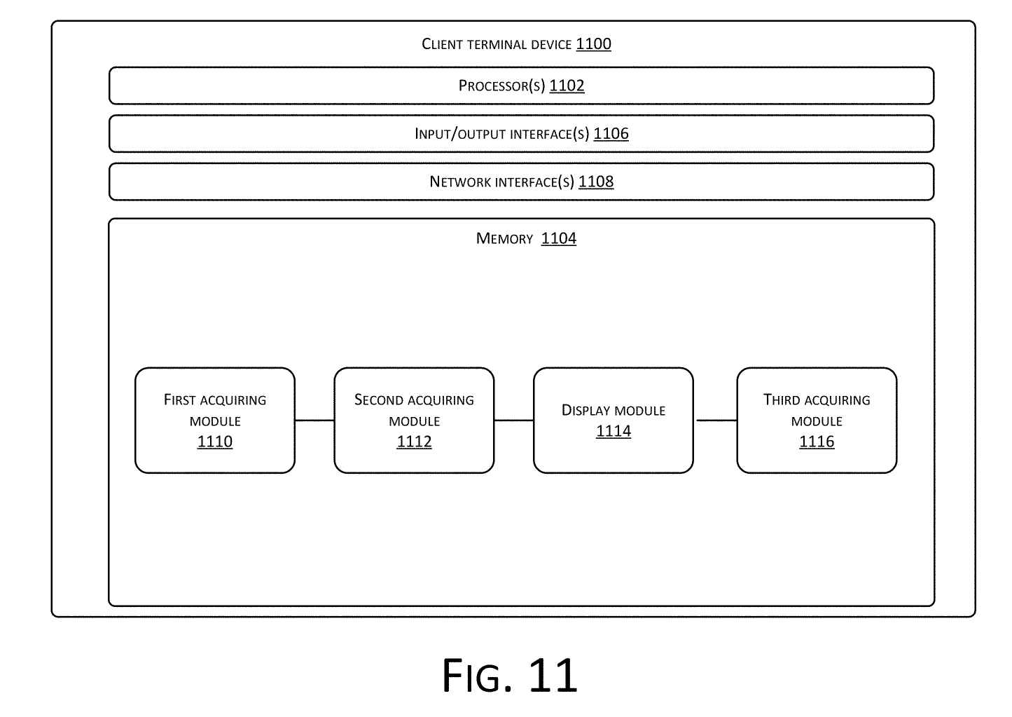

Referring to FIG. 11, a schematic structural diagram of a client terminal device according to an example embodiment of the present disclosure is shown. The client terminal device may implement the universal information providing process described in the foregoing example embodiment. As shown in FIG. 11, a client terminal device 1100 may include one or more processor(s) 1102 or data processing unit(s) and memory 1104. The client terminal device 1100 may further include one or more input/output interface(s) 1106 and one or more network interface(s) 1108. The memory 1104 is an example of computer readable medium or media.

The memory 1104 may store therein a plurality of modules or units including a first acquiring module 1110, a second acquiring module 1112, a display module 1114, and may further include a third acquiring module 1116.

The first acquiring module 1110 is configured to receive a first search request and determine a search time period, wherein the first search request includes information about a first place and information about a second place.

The second acquiring module 1112 is configured to acquire, according to the information about the second place and the search time period, an event occurring at the second place in the search time period.

The display module 1114 is configured to display, in a user interface, information about the event occurring at the second place in the search time period.

The third acquiring module 1104 is configured to receive a second search request submitted based on the user interface, wherein the second search request includes information about a first time; and acquire associated object information according to the information about the first place, the information about the second place, and the information about the first time.

The display module 1114 is further configured to display the acquired object information.

For example, the second acquiring module 1112 is specifically configured to query preset information according to the information about the second place and the search time period, to obtain information about an event occurring at the second place in the search time period, wherein the preset information includes event(s) occurring at N place(s) and occurrence time(s) of the event(s), and N is an integer greater than or equal to 1

In another example, the second acquiring module 1112 is specifically configured to send an event acquisition request to a server, wherein the event acquisition request includes the information about the second place and information about the search time period; and receive an event acquisition response sent by the server according to the event acquisition request, wherein the event acquisition response includes information about the event occurring at the second place in the search time period acquired by the server according to the information about the second place and the search time period.

In another example, the second acquiring module 1112 is specifically configured to query preset information according to the information about the second place and the search time period to obtain information about first-type event(s) occurring at the second place in the search time period, wherein the preset information includes first-type event(s) occurring at N place(s) and occurrence time(s) of the first-type event(s), and N is an integer greater than or equal to 1; send an event acquisition request to the server, wherein the event acquisition request includes the information about the second place and information about the search time period, and receive an event acquisition response sent by the server according to the event acquisition request, wherein the event acquisition response includes information about second-type event(s) occurring at the second place in the search time period acquired by the server according to the information about the second place and the search time period; and obtain, according to the information about the first-type event(s) and the information about the second-type event(s), information about the event occurring at the second place in the search time period.

For example, the event display region of the user interface includes an event label display region and a calendar display region. Correspondingly, the display module 1114 is specifically configured to display, in the event label display region of the user interface, a theme of the event occurring at the second place in the search time period with a label, wherein one event label corresponds to one or more events; and display a calendar related to the search time period in the calendar display region of the user interface.

For example, the display module 1114 is further configured to receive an input operation in the event label display region of the user interface to obtain a selected event label; display, according to the selected event label, a calendar associated with an occurrence time of a corresponding event in the calendar display region of the first user interface; and prompt an occurrence date of the corresponding event on the calendar, or display a recommended travel date on the calendar according to the occurrence date of the corresponding event.

Based on the same technical conception, an example embodiment of the present disclosure further provides a server.

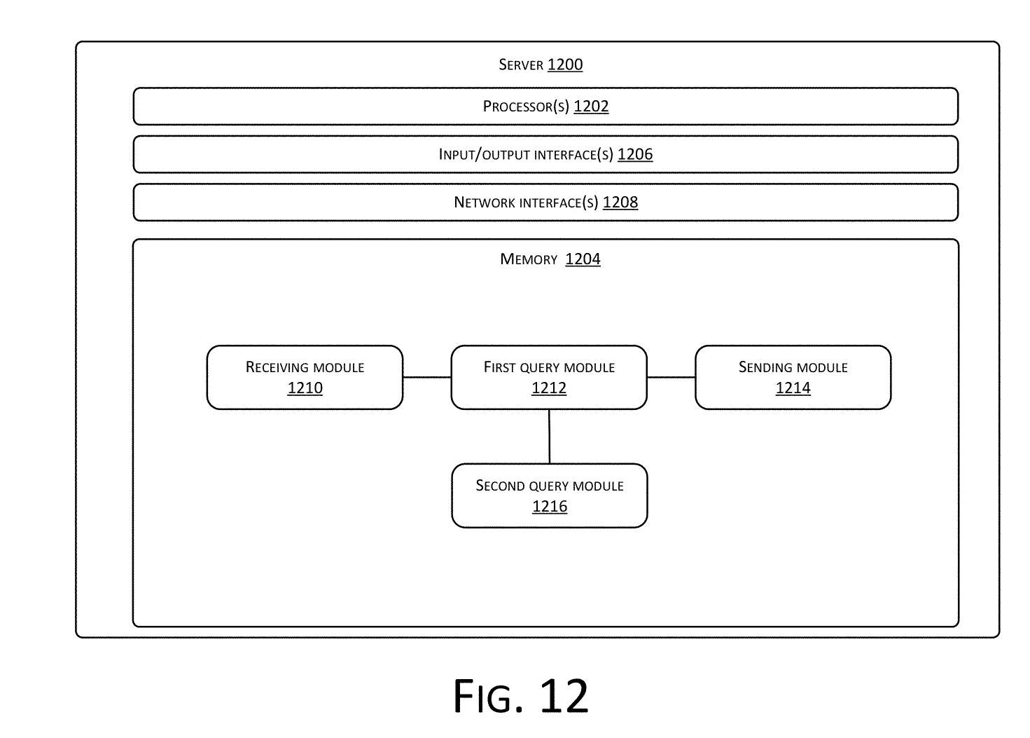

Referring to FIG. 12, a schematic structural diagram of a server according to an example embodiment of the present disclosure is shown. The server may implement the universal information providing process described in the foregoing example embodiment. As shown in FIG. 12, a server 1200 may include one or more processor(s) 1202 or data processing unit(s) and memory 1204. The server 1200 may further include one or more input/output interface(s) 1206 and one or more network interface(s) 1208. The memory 1204 is an example of computer readable medium or media.

The memory 1104 may store therein a plurality of modules or units including a receiving module 1210, a first query module 1212, and a sending module 1214, and may further include a second query module 1216.

The receiving module 1210 is configured to receive a first search request, wherein the first search request includes information about a second place and information about a search time period.

The first query module 1212 is configured to query, according to the information about the second place and the search time period, for information about an event occurring at the second place in the search time period.

The sending module 1214 is configured to send a first search response, wherein the first search response includes the information about the event occurring at the second place in the search time period.

For example, the first query module 1212 is further configured to acquire user preference information after querying for the information about the event occurring at the second place in the search time period; and filter, according to the user preference information, the event occurring at the second place in the search time period.

For example, the receiving module 1210 is further configured to receive a second search request after the first search response is sent, wherein the second search request includes information about a first place, the information about the second place, and information about a first time. The second query module 1216 is configured to query for associated object information according to the information about the first place, the information about the second place, and the information about the first time. The sending module 1214 is further configured to send a second search response, wherein the second search response includes the found object information.

Based on the same technical conception, an example embodiment of the present disclosure further provides a client terminal device.

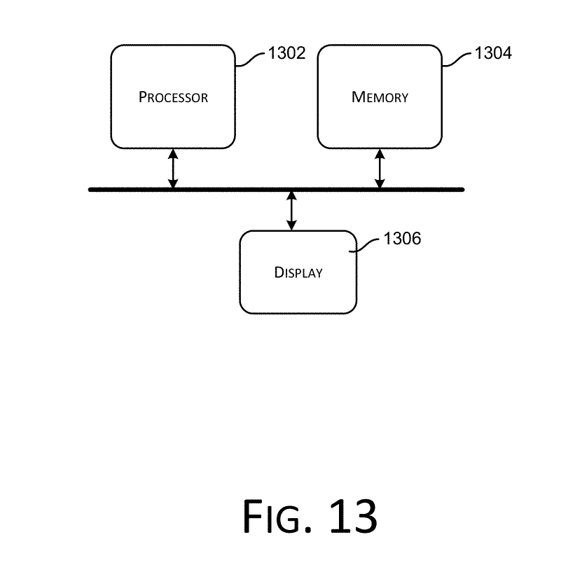

Referring to FIG. 13, a schematic structural diagram of a client terminal device according to an example embodiment of the present disclosure is shown. The client terminal device may implement the information providing process described in the foregoing example embodiment. As shown in the drawing, the client terminal device may include a processor 1302, a memory 1304, and a display 1306.

The processor 1302 may be a general-purpose processor (e.g., a microprocessor or any conventional processor), a digital signal processor, an application-specific integrated circuit, a field programmable gate array, or another programmable logic device, discrete gate or transistor logic device, or a discrete hardware component. The memory 1304 specifically may include an internal memory and/or an external memory, e.g., a mature storage medium in the art such as a random-access memory, a flash memory, a read-only memory, a programmable read-only memory, an electrically erasable programmable memory, a register, or the like. The display 1306 has a function of displaying a user interface.

The processor 1302 is in data communication connection with other modules. For example, data communication may be performed based on a bus architecture. The bus architecture may include any number of interconnected buses and bridges, and specifically various circuits of one or more processors represented by the processor 1302 and memories represented by the memory 1304 may be connected. The bus architecture may further connect various other circuits such as a peripheral device, a voltage regulator, a power management circuits, etc. together. These are all well known in the art, and therefore are not further described in this specification. A bus interface provides an interface. The processor 1302 is responsible for managing the bus architecture and general processing. The memory 1304 may store data used by the processor 1302 when performing operations.

The process disclosed in the example embodiment of the present disclosure may be applied in the processor 1302 or implemented by the processor 1302. In the implementation process, steps in the process described in the foregoing example embodiment may be completed by a hardware integrated logical circuit in the processor 1302 or a software instruction. The methods, steps, and logical block diagrams disclosed in the example embodiments of the present disclosure may be implemented or performed. Steps of the methods disclosed in combination with the example embodiments of the present disclosure may be directly embodied as being executed by a hardware processor or by a combination of hardware and software modules in the processor. The software modules may be located in a mature storage medium in the art such as a random-access memory, a flash memory, a read-only memory, a programmable read-only memory, an electrically erasable programmable memory, a register, or the like.

Specifically, the processor 1302 is coupled to the memory 1304 and configured to read the computer-readable instructions stored in the memory 1304 and perform the following operations in response:

displaying the first user interface by the display, wherein the first user interface includes a travel destination input region;

obtaining a travel destination according to an input operation in the travel destination input region of the first user interface, and determining a search time period;

acquiring, according to the travel destination and the search time period, an event occurring at the travel destination in the search time period; and

displaying the second user interface by the display, wherein the second user interface includes an event display region and a calendar display region, information about the event is displayed in the event display region of the second user interface, and a calendar related to the search time period is displayed in the calendar display region of the first user interface.

For the specific implementation process of the foregoing procedure, reference may be made to the description of the foregoing example embodiment, which is not repeated here.

Based on the same technical conception, an example embodiment of the present disclosure further provides a client terminal device.

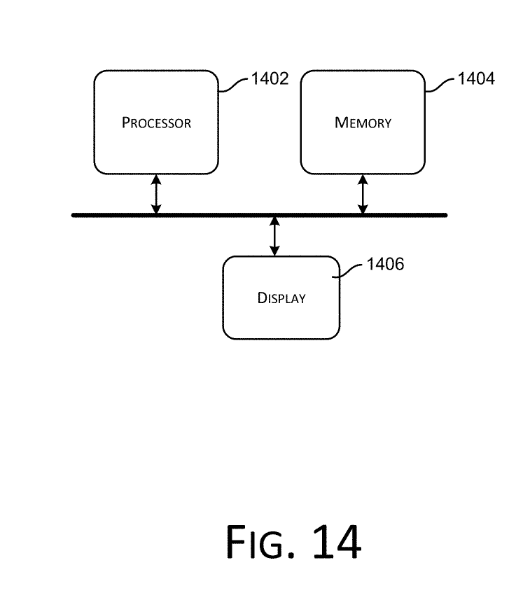

Referring to FIG. 14, a schematic structural diagram of a client terminal device according to an example embodiment of the present disclosure is shown. The client terminal device may implement the universal information providing process described in the foregoing example embodiment. As shown in the drawing, the client terminal device may include a processor 1402, a memory 1402, and a display 1406.

The processor 1402 may be a general-purpose processor (e.g., a microprocessor or any conventional processor), a digital signal processor, an application-specific integrated circuit, a field programmable gate array, or another programmable logic device, discrete gate or transistor logic device, or a discrete hardware component. The memory 1404 specifically may include an internal memory and/or an external memory, e.g., a mature storage medium in the art such as a random-access memory, a flash memory, a read-only memory, a programmable read-only memory, an electrically erasable programmable memory, a register, or the like. The display 1406 has a function of displaying a user interface.

The processor 1402 is in data communication connection with other modules. For example, data communication may be performed based on a bus architecture. The bus architecture may include any number of interconnected buses and bridges, and specifically various circuits of one or more processors represented by the processor 1402 and memories represented by the memory 1402 may be connected. The bus architecture may further connect various other circuits such as a peripheral device, a voltage regulator, a power management circuits, etc. together. These are all well known in the art, and therefore are not further described in this specification. A bus interface provides an interface. The processor 1402 is responsible for managing the bus architecture and general processing. The memory 1404 may store data used by the processor 1402 when performing operations.

The process disclosed in the example embodiment of the present disclosure may be applied in the processor 1402 or implemented by the processor 1402. In the implementation process, steps in the process described in the foregoing example embodiment may be completed by a hardware integrated logical circuit in the processor 1402 or a software instruction. The methods, steps, and logical block diagrams disclosed in the example embodiments of the present disclosure may be implemented or performed. Steps of the methods disclosed in combination with the example embodiments of the present disclosure may be directly embodied as being executed by a hardware processor or by a combination of hardware and software modules in the processor. The software modules may be located in a mature storage medium in the art such as a random-access memory, a flash memory, a read-only memory, a programmable read-only memory, an electrically erasable programmable memory, a register, or the like.

Specifically, the processor 1402 is coupled to the memory 1404 and configured to read the computer-readable instructions stored in the memory 1404 and perform the following operations in response:

receiving a first search request and determining a search time period, wherein the first search request includes information about a first place and information about a second place;

acquiring, according to the information about the second place and the search time period, an event occurring at the second place in the search time period; and

displaying, in a user interface by the display, information about the event occurring at the second place in the search time period.

The processor is further configured to receive a second search request submitted based on the user interface, wherein the second search request includes information about a first time; acquire associated object information according to the information about the first place, the information about the second place, and the information about the first time; and display the acquired object information by the display.

For the specific implementation process of the foregoing procedure, reference may be made to the description of the foregoing example embodiment, which is not repeated here.

Based on the description about the example embodiments above, those skilled in the art may clearly understand that the example embodiments of the present disclosure may be implemented by hardware or by software plus a necessary universal hardware platform. Based on such an understanding, the technical solutions in the example embodiments of the present disclosure may be implemented by a software product. The software product may be stored in a non-volatile storage medium (which may be a CD-ROM, a USB flash disk, a mobile hard disk, or the like) and includes a plurality of instructions for enabling a computer device (which may be a personal computer, a server, a network device, or the like) to execute the methods in the example embodiments of the present disclosure.

Those skilled in the art may understand that the accompanying drawings are merely schematic diagrams of example embodiment, and modules or procedures in the drawings are not necessarily mandatory for implementing the present disclosure.

Those skilled in the art may understand that modules in a terminal of an example embodiment may be distributed in the terminal of the example embodiment according to the description of the example embodiment, or may be alternatively located on one or more terminals different from that in this example embodiment. The modules in the example embodiment may be combined into one module, or further divided into multiple sub-modules.

The sequence numbers of the foregoing example embodiments of the present disclosure do not imply preference among the example embodiments.

Apparently, those skilled in the art may make various modifications and variations on the present disclosure without departing from the spirit and scope of the present disclosure. As such, the present disclosure is intended to cover the modifications and variations if the modifications and variations of the present disclosure fall in the scope of the claims of the present disclosure and their equivalents.

The present disclosure may further be understood with clauses as follows.

Clause 1. An information providing method, the method comprising:

providing a first user interface, the first user interface comprising an event display region and a calendar display region;

obtaining a travel destination and determining a search time period;

acquiring, according to the travel destination and the search time period, an event occurring at the travel destination in the search time period; and

displaying the first user interface, wherein information about the event is displayed in the event display region of the first user interface, and a calendar related to the search time period is displayed in the calendar display region of the first user interface.

Clause 2. The method of clause 1, further comprising providing a second user interface, the second user interface comprising a travel destination input region,

wherein the obtaining the travel destination and determining the search time period comprises:

displaying the second user interface; and

obtaining the travel destination according to an input operation in the travel destination input region of the second user interface, and determining the search time period.

Clause 3. The method of clause 2, wherein:

the determining the search time period comprises:

determining a search start date of the search time period according to a current system time, and determining a search end date of the search time period according to the determined search start date and a default search time length; or

the second user interface further comprises a search start date input region, and the determining the search time period comprises: obtaining the search start date of the search time period according to an input operation in the search start date input region, and determining a search end date of the search time period according to the determined search start date and a default search time length; or

the second user interface further comprises a search end date input region, and the determining the search time period comprises: determining the search start date of the search time period according to the current system time, and obtaining the search end date of the search time period according to an input operation in the search end date input region; or

the second user interface further comprises a search start date input region and a search end date input region, and the determining the search time period comprises: obtaining the search start date of the search time period according to an input operation in the search start date input region, and obtaining the search end date of the search time period according to an input operation in the search end date input region.

Clause 4. The method of clause 1, wherein the acquiring, according to the travel destination and the search time period, the event occurring at the travel destination in the search time period comprises:

querying preset information according to the travel destination and the search time period to obtain information about the event occurring at the travel destination in the search time period, wherein the preset information comprises event(s) occurring at N place(s) and occurrence time(s) of the event(s), and N is an integer greater than or equal to 1.

Clause 5. The method of clause 1, wherein the acquiring, according to the travel destination and the search time period, the event occurring at the travel destination in the search time period comprises:

sending an event acquisition request to a server, wherein the event acquisition request comprises information about the travel destination and information about the search time period; and

receiving an event acquisition response sent by the server according to the event acquisition request, wherein the event acquisition response comprises information about the event occurring at the travel destination in the search time period acquired by the server according to the travel destination and the search time period.

Clause 6. The method of clause 1, wherein the acquiring, according to the travel destination and the search time period, the event occurring at the travel destination in the search time period comprises:

querying preset information according to the travel destination and the search time period to obtain information about first-type event(s) occurring at the travel destination in the search time period, wherein the preset information comprises first-type event(s) occurring at N travel destination(s) and occurrence time(s) of the first-type event(s), and N is an integer greater than or equal to 1;

sending an event acquisition request to a server, wherein the event acquisition request comprises information about the travel destination and information about the search time period, and receiving an event acquisition response sent by the server according to the event acquisition request, wherein the event acquisition response comprises information about second-type event(s) occurring at the travel destination in the search time period acquired by the server according to the travel destination and the search time period; and

obtaining, according to the information about the first-type event(s) and the information about the second-type event(s), information about the event occurring at the travel destination in the search time period.

Clause 7. The method of any of clauses 1 to 6, wherein, after the acquiring the event occurring at the travel destination in the search time period, the method further comprises: acquiring user preference information, and filtering, according to the user preference information, the event occurring at the travel destination in the search time period; and

when the first user interface is displayed, displaying information about the filtered event in the event display region of the first user interface.

Clause 8. The method of any of clauses 1 to 6, wherein:

the event display region of the first user interface comprises an event label display region for displaying a theme of the event occurring at the travel destination in the search time period with a label, and a respective event label corresponds to one or more events;

after displaying the first user interface, the method further comprises:

receiving an input operation in the event label display region of the first user interface to obtain a selected event label;

displaying, according to the selected event label, a calendar associated with an occurrence time of a corresponding event in the calendar display region of the first user interface; and

prompting an occurrence date of the corresponding event on the calendar, or displaying a recommended travel date on the calendar according to the occurrence date of the corresponding event.

Clause 9. The method of clause 8, wherein:

the event display region of the first user interface further comprises an event descriptive information display region; and

after the selected event label is obtained, the method further comprises: displaying descriptive information of the corresponding event in the event descriptive information display region according to the selected event label.

Clause 10. The method of any of clauses 1 to 6, wherein ticket price information for traveling from a place of departure to the travel destination on each date is displayed correspondingly in the displayed calendar.

Clause 11. The method of any of clauses 1 to 6, wherein, after the displaying the first user interface, the method further comprises:

receiving an input operation in the calendar display region to obtain a departure date;

obtaining ticket information for traveling from a place of departure to the travel destination on the departure date according to the place of departure, the travel destination, and the departure date; and

displaying the ticket information.

Clause 12. An information providing method comprising:

receiving an event acquisition request, wherein the event acquisition request comprises information about a travel destination and information about a search time period;

querying, according to the travel destination and the search time period, for information about an event occurring at the travel destination in the search time period; and

sending an event acquisition response, wherein the event acquisition response comprises the information about the event occurring at the travel destination in the search time period.

Clause 13. The method of clause 12, wherein, after the querying for the information about the event occurring at the travel destination in the search time period, the method further comprises:

acquiring user preference information; and

filtering, according to the user preference information, the event occurring at the travel destination in the search time period.

Clause 14. The method of clause 12 or 13, wherein, after the sending the event acquisition response, the method further comprises:

receiving a ticket information query request, wherein the ticket information query request comprises a place of departure, the travel destination, and a departure date;

querying for ticket information for traveling from the place of departure to the travel destination on the departure date according to the place of departure, the travel destination, and the departure date; and

sending a ticket information query response, wherein the ticket information query response comprises the found ticket information.

Clause 15. An information providing method comprising:

receiving a first search request and determining a search time period, wherein the first search request comprises information about a first place and information about a second place;

acquiring, according to the information about the second place and the search time period, an event occurring at the second place in the search time period;

displaying, in a user interface, information about the event occurring at the second place in the search time period;

receiving a second search request submitted based on the user interface, wherein the second search request comprises information about a first time;

acquiring associated object information according to the information about the first place, the information about the second place, and the information about the first time; and

displaying the acquired object information.

Clause 16. The method of clause 15, wherein the acquiring, according to the information about the second place and the search time period, the event occurring at the second place in the search time period comprises:

querying preset information according to the information about the second place and the search time period to obtain information about the event occurring at the second place in the search time period, wherein the preset information comprises event(s) occurring at N place(s) and occurrence time(s) of the event(s), and N is an integer greater than or equal to 1; or

the acquiring, according to the information about the second place and the search time period, the event occurring at the second place in the search time period comprises:
sending an event acquisition request to a server, wherein the event acquisition request comprises the information about the second place and information about the search time period; and
receiving an event acquisition response sent by the server according to the event acquisition request, wherein the event acquisition response comprises information about the event occurring at the second place in the search time period acquired by the server according to the information about the second place and the search time period; or

the acquiring, according to the information about the second place and the search time period, the event occurring at the second place in the search time period comprises:
querying preset information according to the information about the second place and the search time period to obtain information about first-type event(s) occurring at the second place in the search time period, wherein the preset information comprises first-type event(s) occurring at N place(s) and occurrence time(s) of the first-type event(s), and N is an integer greater than or equal to 1;
sending an event acquisition request to a server, wherein the event acquisition request comprises the information about the second place and information about the search time period, and receiving an event acquisition response sent by the server according to the event acquisition request, wherein the event acquisition response comprises information about second-type event(s) occurring at the second place in the search time period acquired by the server according to the information about the second place and the search time period; and
obtaining, according to the information about the first-type event(s) and the information about the second-type event(s), information about the event occurring at the second place in the search time period.

Clause 17. The method of clause 15 or 16, wherein:

an event display region of the user interface comprises an event label display region and a calendar display region;

the displaying, in the user interface, information about the event occurring at the second place in the search time period comprises:

displaying, in the event label display region of the user interface, a theme of the event occurring at the second place in the search time period with a label, wherein a respective event label corresponds to one or more events; and

displaying a calendar related to the search time period in the calendar display region of the user interface.

Clause 18. The method of clause 17, wherein, after the displaying, in the user interface, the information about the event occurring at the second place in the search time period, the method further comprises:

receiving an input operation in the event label display region of the user interface to obtain a selected event label;

displaying, according to the selected event label, a calendar associated with an occurrence time of a corresponding event in the calendar display region of the user interface; and

prompting an occurrence date of the corresponding event on the calendar, or displaying a recommended travel date on the calendar according to the occurrence date of the corresponding event.

Clause 19. The method of clause 18, wherein:

the event display region of the user interface further comprises an event descriptive information display region; and

after obtaining the selected event label, the method further comprises:

displaying descriptive information of the corresponding event in the event descriptive information display region according to the selected event label.

Clause 20. The method of any of clauses 15 to 19, wherein:

the first place is a place of departure;

the second place is a travel destination;

the first time is a departure date; and

the associated object information comprises ticket information for traveling from the place of departure to the travel destination on the departure date.

Clause 21. An information providing method comprising:

receiving a first search request, wherein the first search request comprises information about a second place and information about a search time period;

querying, according to the information about the second place and the search time period, for information about an event occurring at the second place in the search time period; and

sending a first search response, wherein the first search response comprises the information about the event occurring at the second place in the search time period.

Clause 22. The method of clause 21, wherein, after the querying for the information about the event occurring at the second place in the search time period, the method further comprises:

acquiring user preference information; and

filtering, according to the user preference information, the event occurring at the second place in the search time period.

Clause 23. The method of clause 21, wherein, after the sending the first search response, the method further comprises:

receiving a second search request, wherein the second search request comprises information about a first place, the information about the second place, and information about a first time;

querying for associated object information according to the information about the first place, the information about the second place, and the information about the first time; and

sending a second search response, wherein the second search response comprises the found object information.

Clause 24. The method of clause 23, wherein:

the information about the first place is a place of departure;

the information about the second place is a travel destination;

the information about the first time is a departure date; and

the associated object information comprises ticket information for traveling from the place of departure to the travel destination on the departure date.

Clause 25. A client terminal device comprising:

a first acquiring module configured to obtain a travel destination and determine a search time period;

a second acquiring module configured to acquire, according to the travel destination and the search time period, an event occurring at the travel destination in the search time period; and

a display module configured to display a first user interface, wherein the first user interface comprises an event display region and a calendar display region, information about the event is displayed in the event display region of the first user interface, and a calendar related to the search time period is displayed in the calendar display region of the first user interface.

Clause 26. The device of clause 25, wherein the second acquiring module is specifically configured to query preset information according to the travel destination and the search time period to obtain information about the event occurring at the travel destination in the search time period, wherein the preset information comprises event(s) occurring at N place(s) and occurrence time(s) of the event(s), and N is an integer greater than or equal to 1.

Clause 27. The device of clause 25, wherein the second acquiring module is specifically configured to send an event acquisition request to a server, wherein the event acquisition request comprises information about the travel destination and information about the search time period; and receive an event acquisition response sent by the server according to the event acquisition request, wherein the event acquisition response comprises information about the event occurring at the travel destination in the search time period acquired by the server according to the travel destination and the search time period.

Clause 28. The device of clause 25, wherein the second acquiring module is specifically configured to

query preset information according to the travel destination and the search time period to obtain information about first-type event(s) occurring at the travel destination in the search time period, wherein the preset information comprises first-type event(s) occurring at N travel destination(s) and occurrence time(s) of the first-type event(s), and N is an integer greater than or equal to 1;

send an event acquisition request to a server, wherein the event acquisition request comprises information about the travel destination and information about the search time period, and receive an event acquisition response sent by the server according to the event acquisition request, wherein the event acquisition response comprises information about second-type event(s) occurring at the travel destination in the search time period acquired by the server according to the travel destination and the search time period; and

obtain, according to the information about the first-type event(s) and the information about the second-type event(s), information about the event occurring at the travel destination in the search time period.

Clause 29. The device of any of clauses 25 to 28, wherein:

the second acquiring module is further configured to acquire user preference information, and filter, according to the user preference information, the event occurring at the travel destination in the search time period; and

when displaying the first user interface, the display module is configured to display information about the filtered event in the event display region of the first user interface.

Clause 30. The device of any of clauses 25 to 28, wherein:

the event display region of the first user interface comprises an event label display region for displaying a theme of the event occurring at the travel destination in the search time period with a label, and a respective event label corresponds to one or more events; and

the display module is further configured to receive an input operation in the event label display region of the first user interface to obtain a selected event label; display, according to the selected event label, a calendar associated with an occurrence time of a corresponding event in the calendar display region of the first user interface; and prompt an occurrence date of the corresponding event on the calendar, or display a recommended travel date on the calendar according to the occurrence date of the corresponding event.

Clause 31. The device of any of clauses 25 to 28, further comprising:

a ticket query module configured to receive an input operation in the calendar display region to obtain a departure date; and obtain ticket information for traveling from a place of departure to the travel destination on the departure date according to the place of departure, the travel destination, and the departure date,

wherein the display module is further configured to display the ticket information.

Clause 32. A server comprising:

a receiving module configured to receive an event acquisition request, wherein the event acquisition request comprises information about a travel destination and information about a search time period;

an event query module configured to query, according to the travel destination and the search time period, for information about an event occurring at the travel destination in the search time period; and

a sending module configured to send an event acquisition response, wherein the event acquisition response comprises the information about the event occurring at the travel destination in the search time period.

Clause 33. The server of clause 32, wherein the event query module is further configured to:

acquire user preference information; and

filter, according to the user preference information, the event occurring at the travel destination in the search time period.

Clause 34. The server of clause 32 or 33, further comprising a ticket query module,

wherein the receiving module is further configured to receive a ticket information query request, wherein the ticket information query request comprises a place of departure, the travel destination, and a departure date;

the ticket query module is configured to query for ticket information for traveling from the place of departure to the travel destination on the departure date according to the place of departure, the travel destination, and the departure date; and

the sending module is further configured to send a ticket information query response, wherein the ticket information query response comprises the found ticket information.

Clause 35. A client terminal device comprising:

a first acquiring module configured to receive a first search request and determine a search time period, wherein the first search request comprises information about a first place and information about a second place;

a second acquiring module configured to acquire, according to the information about the second place and the search time period, an event occurring at the second place in the search time period;

a display module configured to display, in a user interface, information about the event occurring at the second place in the search time period; and

a third acquiring module configured to receive a second search request submitted based on the user interface, wherein the second search request comprises information about a first time; and acquire associated object information according to the information about the first place, the information about the second place, and the information about the first time,

wherein the display module is further configured to display the acquired object information.

Clause 36. The device of clause 35, wherein:

the second acquiring module is specifically configured to query preset information according to the information about the second place and the search time period to obtain information about the event occurring at the second place in the search time period, wherein the preset information comprises event(s) occurring at N place(s) and occurrence time(s) of the event(s), and N is an integer greater than or equal to 1; or

the second acquiring module is specifically configured to
send an event acquisition request to a server, wherein the event acquisition request comprises the information about the second place and information about the search time period; and
receive an event acquisition response sent by the server according to the event acquisition request, wherein the event acquisition response comprises information about the event occurring at the second place in the search time period acquired by the server according to the information about the second place and the search time period; or

the second acquiring module is specifically configured to
query preset information according to the information about the second place and the search time period to obtain information about first-type event(s) occurring at the second place in the search time period, wherein the preset information comprises first-type event(s) occurring at N place(s) and occurrence time(s) of the first-type event(s), and N is an integer greater than or equal to 1;
send an event acquisition request to a server, wherein the event acquisition request comprises the information about the second place and information about the search time period, and receive an event acquisition response sent by the server according to the event acquisition request, wherein the event acquisition response comprises information about second-type event(s) occurring at the second place in the search time period acquired by the server according to the information about the second place and the search time period; and
obtain, according to the information about the first-type event(s) and the information about the second-type event(s), information about the event occurring at the second place in the search time period.

Clause 37. The device of clause 35 or 36, wherein:

an event display region of the user interface comprises an event label display region and a calendar display region; and

the display module is specifically configured to display, in the event label display region of the user interface, a theme of the event occurring at the second place in the search time period with a label, wherein a respective event label corresponds to one or more events; and display a calendar related to the search time period in the calendar display region of the user interface.

Clause 38. The device of clause 37, wherein the display module is further configured to:

receive an input operation in the event label display region of the user interface to obtain a selected event label;

display, according to the selected event label, a calendar associated with an occurrence time of a corresponding event in the calendar display region of the user interface; and

prompt an occurrence date of the corresponding event on the calendar, or display a recommended travel date on the calendar according to the occurrence date of the corresponding event.

Clause 39. A server comprising:

a receiving module configured to receive a first search request, wherein the first search request comprises information about a second place and information about a search time period;

a first query module configured to query, according to the information about the second place and the search time period, for information about an event occurring at the second place in the search time period; and

a sending module configured to send a first search response, wherein the first search response comprises the information about the event occurring at the second place in the search time period.

Clause 40. The server of clause 39, wherein the first query module is further configured to:

acquire user preference information after querying for the information about the event occurring at the second place in the search time period; and

filter, according to the user preference information, the event occurring at the second place in the search time period.

Clause 41. The server of clause 39, further comprising a second query module, wherein:

the receiving module is further configured to receive a second search request after the first search response is sent, wherein the second search request comprises information about a first place, the information about the second place, and information about a first time;

the second query module is configured to query for associated object information according to the information about the first place, the information about the second place, and the information about the first time; and

the sending module is further configured to send a second search response, wherein the second search response comprises the found object information.

Clause 42. A client terminal device comprising:

a display;

a memory configured to store computer-readable instructions; and

a processor coupled to the memory, and configured to read the computer-readable instructions stored in the memory and perform the following operations in response:
displaying a first user interface by the display, wherein the first user interface comprises a travel destination input region;
obtaining a travel destination according to an input operation in the travel destination input region of the first user interface, and determining a search time period;
acquiring, according to the travel destination and the search time period, an event occurring at the travel destination in the search time period; and
displaying a second user interface by the display, wherein the second user interface comprises an event display region and a calendar display region, information about the event is displayed in the event display region of the second user interface, and a calendar related to the search time period is displayed in the calendar display region of the second user interface.

Clause 43. A client terminal device comprising:

a display;

a memory configured to store computer-readable instructions; and

a processor coupled to the memory, and configured to read the computer-readable instructions stored in the memory and perform the following operations in response:
receiving a first search request and determining a search time period, wherein the first search request comprises information about a first place and information about a second place;
acquiring, according to the information about the second place and the search time period, an event occurring at the second place in the search time period; and
displaying, in a user interface by the display, information about the event occurring at the second place in the search time period,
wherein the processor is further configured to receive a second search request submitted based on the user interface, wherein the second search request comprises information about a first time; acquire associated object information according to the information about the first place, the information about the second place, and the information about the first time; and display the acquired object information by the display.

What is claimed is:

1. A method comprising:
providing a first user interface, the first user interface comprising an event display region and a calendar display region;
obtaining a travel destination;
determining a search time period;
acquiring, according to the travel destination and the search time period, an event occurring at the travel destination in the search time period; and
displaying the first user interface, information about the event being displayed in the event display region of the first user interface, and a calendar related to the search time period being displayed in the calendar display region of the first user interface.

2. The method of claim 1, further comprising providing a second user interface, the second user interface comprising a travel destination input region,
wherein the obtaining the travel destination comprises:
displaying the second user interface; and
obtaining the travel destination according to an input operation in the travel destination input region of the second user interface.

3. The method of claim 2, wherein the determining the search time period comprises:
determining a search start date of the search time period according to a current system time, and determining a search end date of the search time period according to the determined search start date and a default search time length.

4. The method of claim 2, wherein:
the second user interface further comprises a search start date input region; and
the determining the search time period comprises:
obtaining a search start date of the search time period according to an input operation in the search start date input region; and
determining a search end date of the search time period according to the determined search start date and a default search time length.

5. The method of claim 2, wherein:
the second user interface further comprises a search end date input region; and
the determining the search time period comprises:
determining a search start date of the search time period according to a current system time; and
obtaining the search end date of the search time period according to an input operation in the search end date input region.

6. The method of claim 2, wherein:
the second user interface further comprises a search start date input region and a search end date input region; and
the determining the search time period comprises:
obtaining a search start date of the search time period according to an input operation in the search start date input region; and
obtaining the search end date of the search time period according to an input operation in the search end date input region.

7. The method of claim 1, wherein the acquiring, according to the travel destination and the search time period, the event occurring at the travel destination in the search time period comprises:
querying preset information according to the travel destination and the search time period to obtain information about the event occurring at the travel destination in the search time period, wherein the preset information comprises event(s) occurring at N place(s) and occurrence time(s) of the event(s), and N is an integer greater than or equal to 1.

8. The method of claim 1, wherein the acquiring, according to the travel destination and the search time period, the event occurring at the travel destination in the search time period comprises:
sending an event acquisition request to a server, wherein the event acquisition request comprises information about the travel destination and information about the search time period; and
receiving an event acquisition response sent by the server according to the event acquisition request, wherein the event acquisition response comprises information about the event occurring at the travel destination in the search time period acquired by the server according to the travel destination and the search time period.

9. The method of claim 1, wherein the acquiring, according to the travel destination and the search time period, the event occurring at the travel destination in the search time period comprises:
querying preset information according to the travel destination and the search time period to obtain information about first-type event(s) occurring at the travel destination in the search time period, wherein the preset information comprises first-type event(s) occurring at N travel destination(s) and occurrence time(s) of the first-type event(s), and N is an integer greater than or equal to 1;
sending an event acquisition request to a server, wherein the event acquisition request comprises information about the travel destination and information about the search time period, and receiving an event acquisition response sent by the server according to the event acquisition request, wherein the event acquisition response comprises information about second-type event(s) occurring at the travel destination in the search time period acquired by the server according to the travel destination and the search time period; and
obtaining, according to the information about the first-type event(s) and the information about the second-type event(s), information about the event occurring at the travel destination in the search time period.

10. The method of claim 1, wherein, after the acquiring the event occurring at the travel destination in the search time period, the method further comprises:
acquiring user preference information, and filtering, according to the user preference information, the event occurring at the travel destination in the search time period; and
when the first user interface is displayed, displaying information about the filtered event in the event display region of the first user interface.

11. The method of claim 1, wherein:
the event display region of the first user interface comprises an event label display region for displaying a theme of the event occurring at the travel destination in the search time period with a label, and a respective event label corresponds to one or more events;
after displaying the first user interface, the method further comprises:
receiving an input operation in the event label display region of the first user interface to obtain a selected event label;
displaying, according to the selected event label, a calendar associated with an occurrence time of a corresponding event in the calendar display region of the first user interface; and
prompting an occurrence date of the corresponding event on the calendar, or displaying a recommended travel date on the calendar according to the occurrence date of the corresponding event.

12. The method of claim 11, wherein:
the event display region of the first user interface further comprises an event descriptive information display region; and
after the selected event label is obtained, the method further comprises displaying descriptive information of the corresponding event in the event descriptive information display region according to the selected event label.

13. The method of claim 1, further comprising displaying ticket price information for traveling from a place of departure to the travel destination on a corresponding date in the displayed calendar.

14. The method of claim 1, wherein, after the displaying the first user interface, the method further comprises:
receiving an input operation in the calendar display region to obtain a departure date;
obtaining ticket information for traveling from a place of departure to the travel destination on the departure date according to the place of departure, the travel destination, and the departure date; and
displaying the ticket information.

15. A device comprising:
one or more processors; and
one or more memories storing thereon computer-readable instructions that, when executed by one or more processors, cause the one or more processors to perform acts including:
receiving a first search request and determine a search time period, wherein the first search request comprises information about a first place and information about a second place;
acquiring, according to the information about the second place and the search time period, an event occurring at the second place in the search time period;
displaying, in a user interface, information about the event occurring at the second place in the search time period;
receiving a second search request submitted based on the user interface, wherein the second search request comprises information about a first time; and acquire associated object information according to the information about the first place, the information about the second place, and the information about the first time; and
acquiring associated object information according to the information about the first place, the information about the second place, and the information about the first time; and
displaying the acquired object information.

16. The device of claim 15, wherein the acquiring, according to the information about the second place and the search time period, the event occurring at the second place in the search time period comprises:
querying preset information according to the information about the second place and the search time period to obtain information about the event occurring at the second place in the search time period, wherein the preset information comprises event(s) occurring at N place(s) and occurrence time(s) of the event(s), and N is an integer greater than or equal to 1; or
the acquiring, according to the information about the second place and the search time period, the event occurring at the second place in the search time period comprises:
sending an event acquisition request to a server, wherein the event acquisition request comprises the information about the second place and information about the search time period; and
receiving an event acquisition response sent by the server according to the event acquisition request, wherein the event acquisition response comprises information about the event occurring at the second place in the search time period acquired by the server according to the information about the second place and the search time period; or
the acquiring, according to the information about the second place and the search time period, the event occurring at the second place in the search time period comprises:
querying preset information according to the information about the second place and the search time period to obtain information about first-type event(s) occurring at the second place in the search time period, wherein the preset information comprises first-type event(s) occurring at N place(s) and occurrence time(s) of the first-type event(s), and N is an integer greater than or equal to 1;
sending an event acquisition request to a server, wherein the event acquisition request comprises the information about the second place and information about the search time period, and receiving an event acquisition response sent by the server according to the event acquisition request, wherein the event acquisition response comprises information about second-type event(s) occurring at the second place in the search time period acquired by the server according to the information about the second place and the search time period; and
obtaining, according to the information about the first-type event(s) and the information about the second-type event(s), information about the event occurring at the second place in the search time period.

17. The device of claim 15, wherein:
an event display region of the user interface comprises an event label display region and a calendar display region; and
the displaying, in the user interface, information about the event occurring at the second place in the search time period comprises:
displaying, in the event label display region of the user interface, a theme of the event occurring at the second place in the search time period with a label, wherein a respective event label corresponds to one or more events; and
displaying a calendar related to the search time period in the calendar display region of the user interface.

18. The device of claim 17, wherein, after the displaying, in the user interface, the information about the event occurring at the second place in the search time period, the method further comprises:
receiving an input operation in the event label display region of the user interface to obtain a selected event label;
displaying, according to the selected event label, a calendar associated with an occurrence time of a corresponding event in the calendar display region of the user interface; and
prompting an occurrence date of the corresponding event on the calendar, or displaying a recommended travel date on the calendar according to the occurrence date of the corresponding event.

19. The device of claim 18, wherein:
the event display region of the user interface further comprises an event descriptive information display region; and
after obtaining the selected event label, the method further comprises:
displaying descriptive information of the corresponding event in the event descriptive information display region according to the selected event label.

20. The device of claim 15, wherein:
the first place is a place of departure;
the second place is a travel destination;
the first time is a departure date; and
the associated object information comprises ticket information for traveling from the place of departure to the travel destination on the departure date.
